(19) United States
(12) Patent Application Publication
(10) Pub. No.: US 2026/0300289 A1
(43) Pub. Date: Oct. 1, 2026

(54) ARTIFICIAL INTELLIGENCE-ENHANCED INTERACTIVE SEARCH FUNCTIONALITIES FOR WORKSPACES

(71) Applicant: Notion Labs, Inc., San Francisco, CA (US)

(72) Inventors: Andrew Look, San Francisco, CA (US); Amalendu Iyer, San Francisco, CA (US); Tian Jin, San Francisco, CA (US); Elango Kumaran, San Francisco, CA (US); Sarah Sachs, San Francisco, CA (US)

(21) Appl. No.: 19/236,863

(22) Filed: Jun. 12, 2025

Related U.S. Application Data
(60) Provisional application No. 63/780,074, filed on Mar. 28, 2025.

(51) Int. Cl. G06F 16/2453; G06F 16/2452; G06F 16/248

(52) U.S. Cl. CPC G06F 16/24534; G06F 16/24522; G06F 16/248

(57) ABSTRACT

Systems and methods of providing an AI-enhanced search experience are presented. A system can provide one or more search input fields on an interface to receive search queries and present a list of search results including references to content items that satisfy the search query. The search results additionally include a natural language response, based in part on the content items. The system can then receive additional search queries to refine or explore the search results, including summarizing content or answering specific questions based on content in the content items. These results can be saved as part of a search session, and multiple active search sessions can be stored by the system and accessed by a user. The search results can be part of an AI-enabled chat session, and searching for content items can be incorporated as a part of a chat.

### CROSS-REFERENCE TO RELATED APPLICATIONS

This application claims the benefit of priority to U.S. Provisional Application No. 63/780,074, filed Mar. 28, 2025, the contents of which are incorporated by reference herein its entirety.

### BACKGROUND

Workspaces (e.g., digital workspaces) refer to environments that assemble tools and platforms that allow users to work, communicate, and produce work products together. Workspaces can be desktop or web-based applications that allow multiple users to share and access the workspaces in a variety of manners. Workspaces can include compilations of electronic documents that can be organized within the workspace.

When the number of electronic documents in a workspace becomes large, it is important for users to be able to quickly and easily find content that they need. Many collaborative workspaces offer a search functionality to assist users in finding content. Such search functionalities can include, for example, basic keyword matching or rigid categorization systems.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIGS. 3A and 3B are illustrations of a user interface for searching content and displaying search results.

FIG. 4 is an illustration of a user interface configured to display a search-enabled artificial intelligence (AI) chat session.

FIG. 5 is an illustration of a user interface through which multiple active search sessions can be accessed.

FIG. 6 is a flow diagram illustrating a process for providing an AI-enhanced interactive search of content items accessible via a workspace.

FIG. 7 is an illustration of a user interface including multiple input fields that can determine the context of a search query.

FIG. 8 is an illustration of a user interface including a chat-like interface for exploring content accessible through a workspace.

FIG. 9 is a flow diagram illustrating a process for providing an intent-aware, AI-enhanced interactive search of content items accessible via a workspace.

FIG. 10 illustrates a user interface for generating documents including content based on search results in a workspace.

FIG. 11 is a flow diagram illustrating a process for generating a document based on the surfaced content items from a search.

FIG. 12 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for systems and methods for an enhanced search functionality of a workspace by incorporating generative artificial intelligence (AI), such as a large language model (LLM).

The integration of artificial intelligence (AI) technologies into software applications has been beneficial in many areas for enhancing user experiences. However, the use of AI within search functions often falls within either the category of simply summarizing search results found by another method or generating potentially outdated information contained within a pretrained AI model. The present technology enables a search query entered by a user to result in both a list of search results and an entry point to an AI-enabled chat session where the user can further refine the search results and investigate surfaced content. The technology enables this information to be presented to the user in the format of an itemized list of search results and/or in the format of an interactive chat session with search results embedded into chat responses. For example, a search result list is combined with an AI chat experience to allow a user to investigate search results using generative AI, which allows the user to generate explanations and summaries of search results or to assist the user in surfacing new search results.

The presented results can depend on an intent of a search query. The intent of the search query can be determined by the system, for example, by processing the query by AI. In an instance where the system determines that a user has a navigational intent (e.g., the user is trying to find and access a specific content item that they believe exists), the system can present search results that prioritize traditional itemized results, including the titles of pages of the workspace that are likely to be the page the user is attempting to navigate to. In an instance where the user has an exploratory intent (e.g., the user is searching for the answer to a particular question), the system can instead prioritize an AI summary of search results without presenting the search results themselves. In some implementations, the system detects intent based on the entry point of the search query on an interface of the workspace. For example, a workspace can present an interface with a conventional search bar that is configured to receive queries of navigational intent and a second input field (such as a chat window) that is configured to receive queries of exploratory intent. In some implementations, the intent is determined based on characteristics of the search query. For example, traditional keyword search queries can result in priority being placed on the itemized list of results, whereas natural language search queries can result in priority being placed on a natural language summary of search results.

Additionally, the present technology allows users to create documents based on the search results. For example, a search query such as “new documents created by Company A” can be followed by the prompt “create a press release covering recent progress made by Company A,” which can generate a document based on the prompt and the results of the search query.

In one example, there can be a computer-implemented method for performing navigational and exploratory searches of content accessible via a workspace, the workspace including a collection of content items, the method comprising: receiving, at a first input field, a preliminary search query for content items that are accessible via the workspace; identifying a first set of content items that satisfy the preliminary search query; generating, using an artificial intelligence (AI) system, a first natural language response that satisfies the preliminary search query, wherein the first natural language response is generated based on content items that are accessible via the workspace; causing presentation, on an interface of the workspace, of: preliminary search results including indications of the first set of content items and the first natural language response, and a second input field configured to enable investigation of the preliminary search results; receiving, at the second input field, a refined search query in a natural language format; and causing presentation, on the interface of the workspace, of refined search results including indications of a second set of content items and a second natural language response that satisfies the refined search query. The computer-implemented method can further comprise: embedding links to particular content items in a particular natural language response that satisfies a particular search result. The preliminary search results can correspond to first preliminary search results, wherein receiving the preliminary search query at the first input field can initiate a first search session, and wherein the method can further comprise: initiating a second search session by receiving a second preliminary search query for content items that are accessible via the workspace; and causing presentation, on the interface of the workspace, of a third input field and second preliminary search results including a third set of content items and a third natural language response, wherein the third input field is configured to enable investigation of the second preliminary search results, and wherein (i) the first search session comprising the first set of content items, the first natural language response, and the second input field and (ii) the second search session comprising the third set of content items, the third natural language response, and the third input field are both accessible via the interface of the workspace. The computer-implemented method can further comprise: causing presentation, on the interface of the workspace, of an interface element, wherein activating the interface element indicates an intent to change search sessions; and causing presentation, on the interface of the workspace, of the first preliminary search results and the second input field. The first set of content items can be an empty set containing zero content items, the first natural language response can identify that no content items were found, and the method can further comprise: in response to the first set of content items being an empty set, initialize an AI-enabled chat session, wherein the second input field is configured to receive a new search query. Each item in the first set of content items can be retrievable from the workspace. A portion of the content items accessible via the workspace can be content items retrieved from a source that is outside of the workspace. This computer-implemented method can further comprise: causing presentation, on the interface of the workspace, a list of one or more sources of content items, the content items being accessible via the workspace, wherein each of the one or more sources is selectable through the interface of the workspace; and wherein the preliminary search results only include content items in the first set of content items that are from one or more selected sources. The first natural language response can be generated based on content items in the first set of content items. The computer-implemented method can further comprise, prior to generating the first natural language response that satisfies the preliminary search query: initialize a chat session with the AI system, wherein the chat session includes a series of exchanges, comprising inputs and responses, in which context is maintained between exchanges in the series; and inputting, as part of the chat session, the refined search query to the AI system to generate the second natural language response. The content items can be blocks of the workspace, wherein the blocks are configured in accordance with a block data model.

In another example, there can be at least one non-transitory, computer-readable storage medium comprising instructions recorded thereon, wherein the instructions, when executed by at least one data processor of a system, cause the system to: identify a first set of content items satisfying a preliminary search query, wherein each of the first set of content items are accessible via a workspace, and wherein the preliminary search query is entered into a first input field; generate, using an artificial intelligence (AI) system, a first natural language response that satisfies the preliminary search query, wherein the first natural language response is generated based at least in part on content items accessible via the workspace; cause presentation, on an interface of the workspace, of: preliminary search results including indications of the first set of content items and the first natural language response, and a second input field; and cause presentation, on the interface of the workspace, of refined search results including a second natural language response that satisfies a refined search query, wherein the refined search query is entered into the second input field. The preliminary search results can correspond to first preliminary search results, wherein a first search session is initiated in response to the preliminary search query being entered into the first input field, and wherein the storage medium can further include instructions to cause the system to: initiate a second search session in response to second preliminary search query being entered into a third input field; and cause presentation, on the interface of the workspace, of a fourth input field and a third natural language response that satisfies the second preliminary search query, wherein (i) the first search session containing the first set of content items, the first natural language response, and the second input field and (ii) the second search session containing, the third natural language response and the fourth input field are both accessible via the interface of the workspace. This at least one non-transitory, computer-readable storage medium can specify that the third input field is the first input field. A portion of the content items accessible via the workspace can be content items from a source that is outside of the workspace. The at least one non-transitory, computer-readable storage medium can further include instructions to cause the system to: cause presentation, on the interface of the workspace, a list of one or more sources of content items, the content items being accessible via the workspace, wherein each of the one or more sources is selectable through the interface of the workspace; and wherein the preliminary search results only include content items in the first set of content items that are from one or more selected sources. The at least one non-transitory, computer-readable storage medium can further include instructions to cause the system to: concurrent with causing presentation the refined search results, cause presentation of an interface element, wherein interacting with the interface element causes presentation of indications of a second set of content items satisfying the refined search query.

In another example, there can be a system comprising: at least one hardware processor; and at least one non-transitory memory storing instructions, which, when executed by the at least one hardware processor, cause the system to: generate, using an artificial intelligence (AI) system, a first natural language response satisfying a preliminary search query, wherein the preliminary search query is entered into a first input field; cause presentation, on a user interface, of: preliminary search results including the first natural language response, and a second input field; and cause presentation, on the user interface, of refined search results including a set of content items satisfying a refined search query and a second natural language response satisfying the refined search query, wherein the refined search query is entered into the second input field. wherein each of the set of content items are accessible via a workspace. Instructions stored on the memory can further cause the at least one hardware processor to, prior to generating the first natural language response: initialize a chat session with the AI system, wherein the chat session includes a series of exchanges, comprising inputs and responses, in which context is maintained between exchanges in the series; and input, as part of the chat session, the refined search query to the AI system to generate the second natural language response. The preliminary search query can correspond to first preliminary search query, wherein the preliminary search results corresponds to first preliminary search results, wherein instructions stored on the memory further cause the at least one hardware processor to: generate, using the AI system, a third natural language response satisfying a second preliminary search query, wherein the preliminary search query is entered into a third input field; cause presentation, on the user interface, of second preliminary search results including the third natural language response and a fourth input field, wherein (i) the first preliminary search results including the first natural language response and the second input field and (ii) the second preliminary search results including the third natural language response and the fourth input field are both accessible via the user interface.

In another example, there can be a computer-implemented method for presenting results of a search query responsive to a determination of an intent of the search query, the results based on content items accessible through a workspace, the workspace including a collection of content items, the method comprising: receiving, at an input field on a user interface of the workspace, a search query; determining an intent of the search query based on processing the content of the search query and identifying an input field of a plurality of input fields on the user interface that received the search query; compiling preliminary results that satisfy the search query, the preliminary results comprising: a set of content items that satisfy the search query, and a natural language response to the search query, wherein the natural language response is generated as output of a generative artificial intelligence (AI) system based at least in part on input including the set of content items that satisfy the search query; and causing presentation, on an interface of the workspace, of the preliminary results, wherein presented representations of the preliminary results are configured to prioritize either references to content items in the set of content items or the natural language response, wherein the prioritization is based on the determined intent of the search query. Receiving a search query can comprise: causing concurrent presentations, on the interface of the workspace, of a first input field in a first location of the user interface and a second input field in a second location of the user interface different from the first location, and receiving the search query at either the first input field or the second input field; and wherein determining an intent of the search query can comprise identifying whether the first input field or the second input field received the search query. Receiving a search query can comprise: causing concurrent presentations, on the interface of the workspace, of a first input field in a first location of the user interface and a second input field in a second location of the user interface different from the first location, and receiving the search query at either the first input field or the second input field; wherein in response to identifying that the first input field received the search query, the preliminary search results are configured to prioritize references to content items in the set of content items that satisfy the search query; and wherein in response to identifying that the second input field received the search query, the preliminary search results are configured prioritize the natural language response to the search query. Determining the intent of the search query can comprise: recognizing, based on processing the content of the search query, that the search query is in a keyword search format; and determining, based on the recognition, that the intent of the search query is to identify content items accessible through the workspace that satisfy the search query. Determining the intent of the search query can comprise: recognizing, based on processing the content of the search query, that the search query is in a natural language format; and determining, based on the recognition, that the intent of the search query is to receive generated content including a natural language response to the search query that is generated based on content items accessible through the workspace. The computer-implemented method can further comprise: causing presentation, on the interface of the workspace, of an input field of a chatbot configured to enable exploration of the preliminary results; receiving, at the input field, an additional search query in a natural language format; and initiating a chat session including presentation, on the interface of the workspace, of updated results, the updated results comprising: an additional reference to a content item that satisfies the additional search query, and an additional natural language response to the additional search query. The determined intent of the search query can be to prioritize itemized content, and wherein causing presentation of the preliminary results on the interface of the workspace can comprise causing presentation of references to content items in the set of content items that satisfy the search query while de-emphasizing the natural language response to the search query. The determined intent of the search query can be to prioritize generated content, and causing presentation of the preliminary results on the interface of the workspace can comprise causing presentation of the natural language response to the search query while de-emphasizing references to content items in the set of content items that satisfy the search query. The determined intent of the search query can be to prioritize generated content; causing presentation of the preliminary results on the interface of the workspace can comprise causing presentation of the natural language response to the search query while de-emphasizing references to content items in the set of content items that satisfy the search query; and the method can further comprise causing presentation, on the interface of the workspace, of an interface element, wherein interacting with the interface element causes presentation of emphasized references to content items concurrently with the presentation of the natural language response. The determined intent of the search query can be to include both itemized content and generated content, and causing presentation of the preliminary results on the interface of the workspace can comprise causing presentation, on the interface of the workspace, of (i) references to content items in the of content items that satisfy the search query and (ii) the natural language response to the search query. The determined intent of the search query can be to include both itemized content and generated content and to prioritize either itemized content or generated content; and causing presentation of the preliminary results on the interface of the workspace can comprise: causing presentation, on the interface of the workspace, of (i) references to content items in the of content items that satisfy the search query and (ii) the natural language response to the search query, and wherein a relative size of the references to content items and the natural language response is based on the determined intent of the search query. The workspace can implement a block data model and at least one content item can be a block.

In another example, there can be at least one non-transitory, computer-readable storage medium comprising instructions recorded thereon, wherein the instructions, when executed by at least one data processor of a system, cause the system to: cause concurrent presentations, at an interface of a workspace, of a first input field at a first location of the interface and a second input field at a second location of the interface, wherein the first input field and the second input field are configured to cause the workspace to, in response to receiving a search query, perform at least one of: a search for content items that satisfy the search query, or a generation of a natural language response to the search query, wherein the first input field is weighted to prioritize references to content items that satisfy a received search query, and wherein the second input field is weighted to prioritize generated content that satisfies a received search query; in response to receiving a first search query at the first input field, cause presentation, at the interface of the workspace, of first search results that are weighted to prioritize references to content items that satisfy the first search query; and in response to receiving a second search query at the second input field, cause presentation, at the interface of the workspace, of second results that are weighted to prioritize a natural language response to the second search query, wherein the natural language response is generated using and artificial intelligence (AI) system. The at least one non-transitory, computer-readable storage medium can further comprise instructions that cause the system to: in response to receiving the first search query at the first input field: initiate a chat session; and cause presentation, on the interface of the workspace, of: a list of references to content items that satisfy the first search query, and an interactive chat window of the chat session including the natural language response to the first search query and a third input field for user inputs to explore the content items. The at least one non-transitory, computer-readable storage medium can further comprise instructions that cause the system to: in response to receiving the second search query at the second input field: initiate a chat session; and cause presentation, on the interface of the workspace, of an interactive chat window of the chat session, wherein the interactive chat window includes the natural language response to the second search query, and wherein the second input field is further configured to accept prompts that are part of the chat session. The at least one non-transitory, computer-readable storage medium can further comprise instructions that cause the system to: cause presentation, on a page of the workspace, of a link to a page of the content items that satisfy the first search query.

In another example, there can be a system comprising: at least one hardware processor; and at least one non-transitory memory storing instructions, which, when executed by the at least one hardware processor, cause the system to: cause presentation, on an interface of a workspace, a first input field in a first location and a second input field in a second location; compile, in response to receiving a search query at either the first input field or the second input field, a set of content items accessible through the workspace that satisfies the search query; generate, in response to receiving the search query at either the first input field or the second input field and based at least in part on the compiled set of content items, a natural language response that satisfies the search query; cause presentation, on an interface of the workspace, representations of the references to content items in the compiled set of content items and/or the natural language response, wherein the representations are configured to prioritize either the references to content items or the natural language response, wherein the prioritization is based at least in part on whether the first input field or the second input field received the search query. Instructions stored on the memory can further cause the system to: prior to causing presentation of representations of the references to content items and/or the natural language response, configure the representations, wherein the representations are configured to prioritize the references to content items in response to the search query being received at the first input field, and wherein the representations are configured to prioritize the natural language response in response to the search query being received at the second input field. Instructions stored on the memory can further cause the system to: prior to causing presentation of representations of the references to content items and/or the natural language response, configure the representations, wherein the representations are configured to prioritize the references to content items in response to (i) the search query being received at the first input field, and (ii) a determination that the search query is in a keyword search format, wherein representations are configured to prioritize the natural language response in response to (i) the search query being received at the first input field, and (ii) a determination that the search query is in a natural language format, and wherein the representations are configured to prioritize the natural language response in response to the search query being received at the second input field. Instructions stored on the memory can further cause the system to: in response to the search query being received at the second input field, initiate a chat session; and in response to the search query being received at the second input field, cause presentation, on the interface of the workspace, of an interactive chat window of the chat session including the natural language response and a third input field for user inputs to engage in the chat session.

In another example, there can be a system for generating, in a workspace, documents based on search results, the system comprising: at least one processor; and at least one non-transitory computer-readable storage medium storing instructions that, when executed by the at least one processor, cause the system to: receive, on an interface of the workspace, a search query for content items accessible via the workspace; compile search results that satisfy the search query, the search results comprising: references to content items that satisfy the search query, wherein the content items are accessible via the workspace, and a natural language response to the search query, wherein the natural language response is generated as output of a generative artificial intelligence (AI) system based at least in part on input including the content items that satisfy the search query; cause presentation, on the interface of the workspace, of the search results and a document generation interface; receive, via the document generation interface, an instruction to generate a document based on at least a portion of the search results, wherein the at least a portion of the search results comprises content items accessible via the workspace and/or the natural language response; generate the document based on at least the instruction and the at least a portion of the search results, wherein the document comprises content generated by the AI system based on the at least a portion of the search results; and provide the document on the document generation interface of the workspace. The document can be a content item contained in the workspace; and the document can contain an automatically updating element, wherein the automatically updating element comprises a value that dynamically reflects an attribute of the workspace. The document generation interface can comprise an interface element configured to provide, in response to a selection of the interface element, instructions to an AI system to generate the document; and receiving the instruction to generate the document can comprise receiving a user selection of the interface element. The document generation interface can comprise an input field; and the instruction to generate the document can comprise a natural language instruction provided by a user at the input field. The document generation interface can comprise an input field; the instruction to generate the document can comprise a natural language instruction provided by a user at the input field; and the natural language instruction can be processed using the AI system to determine parameters for generating the document.

The document generation interface can comprise a plurality of selectable interface elements associated with different document type options; and the instruction to generate a document can comprise a selection of a selectable interface element, associated with a particular document type option, of the plurality of selectable interface elements, wherein a type of the generated document is determined by the particular document type option. Each of the presented references to content items can be selectable; and the at least a portion of the search results can include only the content items referred to by selected references and/or the natural language response. The document generation interface can comprise an input field; the instruction to generate the document can comprise a natural language instruction provided by a user at the input field; the natural language instruction can identify certain content items; and the at least a portion of the search results can include only the content items identified in the natural language instruction. The search query can correspond to a first search query, search results can correspond to first search results, references to content items can correspond to first references to content items, the natural language response can correspond to a first natural language response, and instructions stored on the computer-readable storage medium can further cause the system to: receive, prior to receiving the instruction to generate the document, a second search query for content items accessible via the workspace; compile second search results that satisfy the second search query, the second search results comprising: second references to content items that satisfy the second search query, wherein the content items that satisfy the second search query are accessible via the workspace, and a second natural language response, wherein the second natural language response is generated as output of the AI system based at least in part on input including the content items that satisfy the second search query; and wherein generating the document further comprises: generating the document based at least in part on content items that satisfy the second search query and/or the second natural language response.

In another example, there can be a method for generating documents based on search results, comprising: receiving, on an interface of a workspace, a search query for content items accessible via the workspace; compiling search results that satisfy the search query, the search results comprising: references to content items that satisfy the search query, wherein the content items are accessible via the workspace, and a natural language response to the search query, wherein the natural language response is generated as output of a generative artificial intelligence (AI) system based at least in part on input including the content items that satisfy the search query; causing presentation, on the interface of the workspace, of the search results; receiving, via the interface of the workspace, an instruction to generate a document based on at least a portion of the search results, wherein the at least a portion of the search results comprises content items accessible via the workspace and/or the natural language response; generating the document based on at least the instruction and the at least a portion of the search results, wherein the document comprises content generated by the AI system based on the at least a portion of the search results; and provide the document on the interface of the workspace. The interface can comprise an interface element configured to provide, in response to a selection of the interface element, instructions to an AI system to generate the document; and receiving the instruction to generate the document can comprise receiving a user selection of the interface element. The interface can comprise an input field; the search query can be received at the input field; and the instruction to generate the document can comprise a natural language instruction received at the input field. The interface can comprise an input field; the instruction to generate the document can comprise a natural language instruction provided by a user at the input field; and the natural language instruction can be processed using the AI system to determine parameters for generating the document. The interface can comprise a plurality of selectable interface elements associated with different document type options; and the instruction to generate a document can comprise a selection of a selectable interface element, associated with a particular document type option, of the plurality of selectable interface elements, wherein a type of the generated document is determined by the particular document type option. Each of the presented references to content items can be selectable, and the at least a portion of the search results can include only the content items referred to by selected references and/or the natural language response. The interface can comprise an input field; the instruction to generate the document can comprise a natural language instruction provided by a user at the input field; the natural language instruction can identify certain content items; and the at least a portion of the search results can include only the content items identified in the natural language instruction.

In another example, there can be a system for generating, in a workspace, workflow structures based on search results, the workflow structures being content items contained in the workspace, the system comprising: at least one processor; and at least one non-transitory computer-readable storage medium storing instructions that, when executed by the at least one processor, cause the system to: receive, on an interface of the workspace, a search query for content items accessible via the workspace; compile search results that satisfy the search query, the search results comprising: references to content items that satisfy the search query, wherein the content items are accessible via the workspace, and a natural language response to the search query, wherein the natural language response is generated as output of a generative artificial intelligence (AI) system based at least in part on input including the content items that satisfy the search query; cause presentation, on the interface of the workspace, of the search results and a workflow structure generation interface; receive, via the workflow structure generation interface, an instruction to generate a workflow structure based on at least a portion of the search results, wherein the at least a portion of the search results comprises content items accessible via the workspace and/or the natural language response; generate the workflow structure based on at least the instruction and the at least a portion of the search results, wherein the workflow structure comprises a set of interconnected tasks or activities generated by the AI system based on the at least a portion of the search results; and provide the workflow structure on the workflow structure generation interface.

The workflow structure can be a schedule; and the set of interconnected tasks or activities can be arranged in a temporal order. The workflow structure can comprise a schedule provided on a calendar associated with the workspace; and the calendar can comprise an interactive element that, when activated through the interface of the workspace, updates a status of a task or activity in the calendar. The workflow structure can be a tracker; and the tracker can include an interactive element that, when activated through the interface, updates a status of a task to be completed in the workspace.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

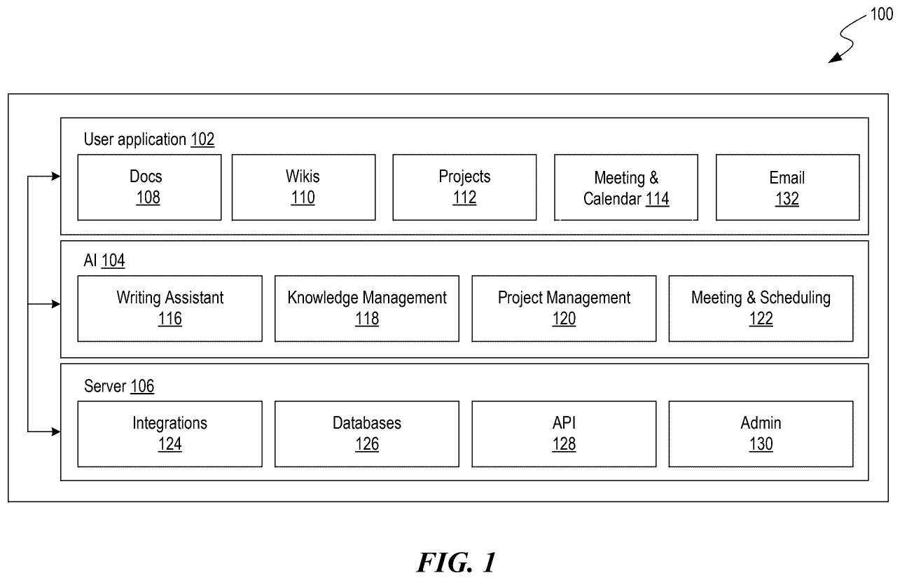

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

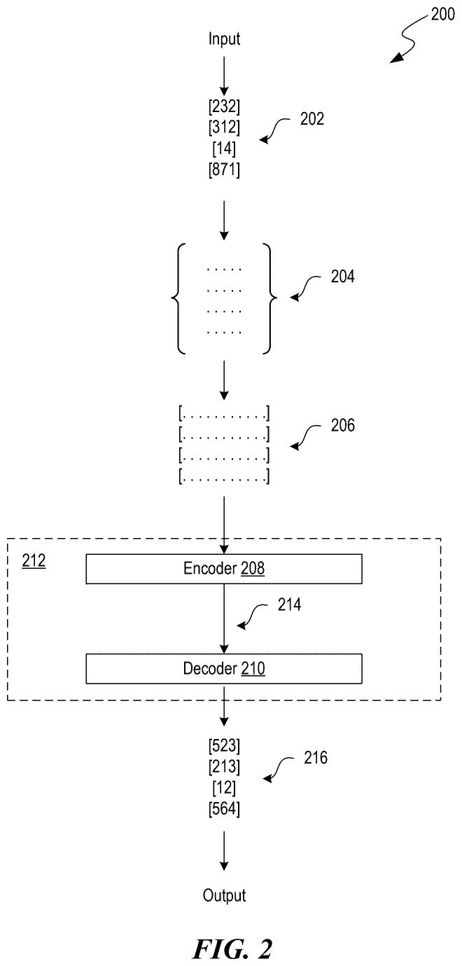

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Chat-Enabled Search

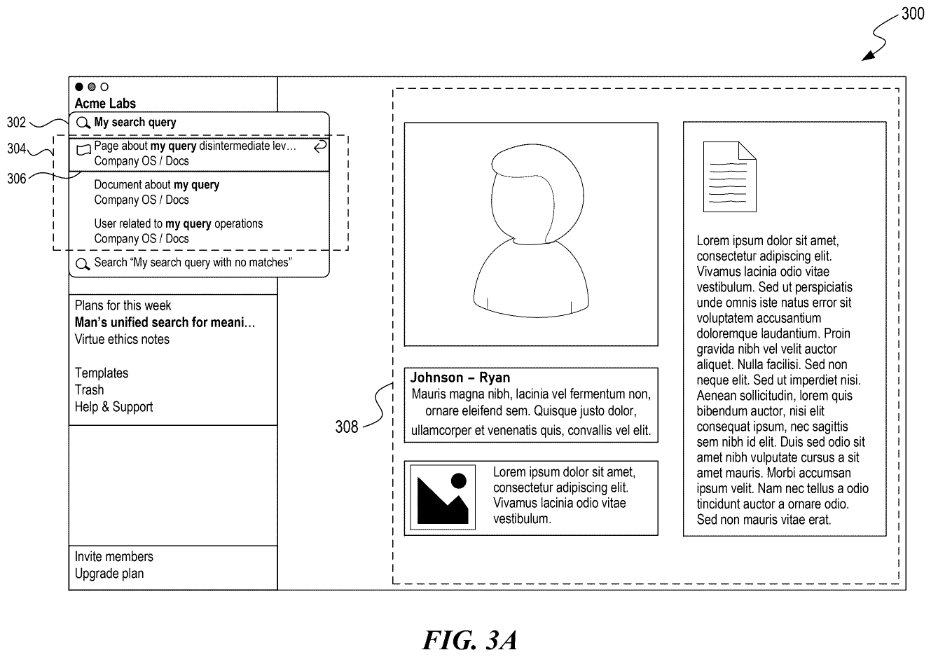

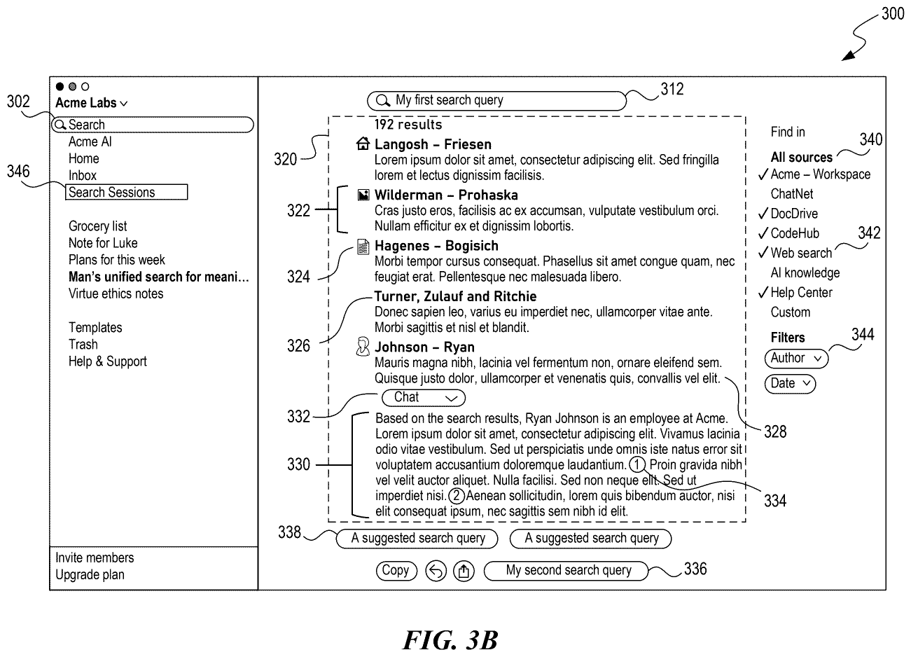

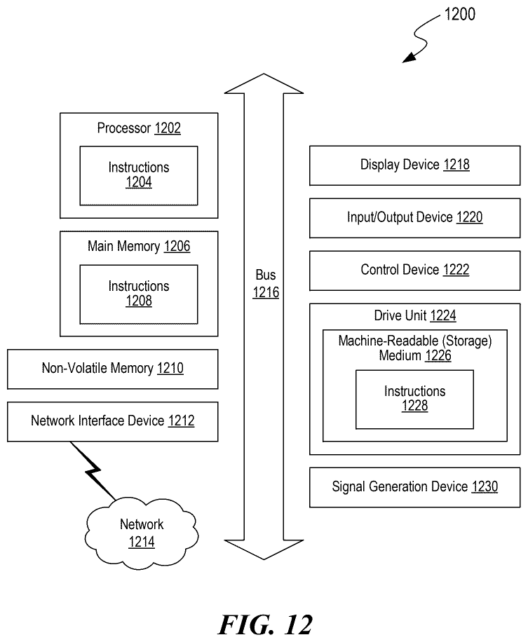

FIGS. 3A and 3B are illustrations of a UI 300 for searching content and displaying search results. The UI 300 can be displayed on a display of an electronic device (e.g., a computer system 1200 described with respect to FIG. 12). The UI 300 can display information associated with a workspace, which can include a collection of content items, for example, documents, images, videos, multimedia files, pages, user profiles, emails, blocks conforming to a block data model, and the like. The workspace can be associated with a system, including a database (or a data storage) storing the data included in the workspace, that can cause presentation of the UI 300. The UI 300 can be configured to display content that is accessible from the workspace, including content items from the collection of content items and may additionally include content items from external sources, such as external databases, websites, or domains. The workspace can be part of the platform 100 shown in FIG. 1.

In FIG. 3A, the UI 300 is configured to initiate a search and display a list of search results. The UI 300 can include a search input field 302 configured to receive search queries. In the UI 300, the search input field 302 is positioned on the sidebar region of the UI 300. A sidebar region of a UI can generally include interface elements that allow a user to easily navigate and access content and functions of a workspace. Alternatively, the search input field 302 can be positioned in different regions of the UI 300 (e.g., on a different sidebar region, on the top or bottom of the UI 300, or within a page displayed on the UI 300). In some implementations, the input field can be part of a UI that can connect to the workspace (e.g., presented by a desktop application that can connect to the workspace and/or multiple workspaces). As used herein, a search query or a query can refer to an input including natural language text and/or one or more keywords that a user enters in order to identify, search, retrieve and/or generate content. Generated content can include text, images, emails, documents, workflows, blocks, and/or natural language responses such as summaries and/or chat-like responses.

In some implementations, the UI 300 presents search results 304, including a list of content references 306. As shown in FIG. 3A, the search results 304 are provided adjacent to the search input field 302 (e.g., the search results 304 are positioned immediately below the search input field 302). The content references 306 can include references or indications (e.g., links, previews, icons, or names) associated with content that is responsive to the received query. The content can be located within the workspace (e.g., blocks, pages, documents, or emails within the workspace) or be located outside the workspace (e.g., on the Internet). The search results 304 can update dynamically as a user enters text into the search input field 302. The search results 304 can be configured to function as a quick search, requiring less time to present than a full search (e.g., the search results 320 described with respect to FIG. 3B). This could include prioritizing content items based on statistics (e.g., number of interactions and/or time since last interaction by the user initiating the search, number of interactions by all users of a workspace, and/or type of interaction by user initiating the search) rather than on the content of the content items or could include a weighted consideration of both statistics and content.

In some implementations, the search input field 302 and the search results 304 are presented alone or with page content 308. For example, the search input field 302 can be presented as part of a sidebar or menu that can be accessed from multiple places in the workspace, as shown in FIG. 3A. In some implementations, the search input field 302 and the search results 304 are accessible from multiple pages of the workspace, with page content 308 being the content of a page of the workspace. As shown, the search results 304 do not include any additional content, such as AI-generated content.

In FIG. 3B, the UI 300 is configured to display search results and a natural language summary in response to a search query. The UI 300 can present more extensive search results 320, including a search bar 312, a list of content references 322, a natural language response 330, and/or a chat input field 336. The natural language response 330 can satisfy the search query and can incorporate content from the content items identified by the content references 322. As shown, the search results 320 can be positioned on a content section (e.g., a page) positioned in the middle region of the UI 300. The natural language response 330 can be generated by a generative artificial intelligence (AI) model, such as a machine learning (ML) model and/or a large language model (LLM) (e.g., models incorporating a transformer 212 described with respect to FIG. 2). The search bar 312 can be configured to receive a search query and present content references 322 that satisfy the search query and/or a natural language response 330 that satisfies the search query. For example, entering a different search query into the search bar 312 can lead to the presentation of different content references 322 and/or a different natural language response 330. In another example, the content references 322 and/or natural language response 330 can satisfy a search query received at the search input field 302, and a second search query entered into the search bar 312 can result in different content references 322 and/or a different natural language response 330 that satisfies the second search query.

By presenting both an itemized list of content references with an AI-generated natural language response, the UI 300 can provide a comprehensive and user-friendly search experience. Users can quickly scan the content references to find specific documents or resources they are looking for, while also benefiting from the AI-generated summary or explanation that can provide context, answer questions, or offer insights based on the search query. This dual presentation can potentially save time and effort for users, as they can choose to explore the detailed content references or rely on the concise natural language response, depending on their specific needs. Additionally, the natural language response can help users better understand complex topics or synthesize information from multiple sources, enhancing comprehension and decision-making. This approach can also allow for natural and intuitive interactions with the search interface, as users can refine search queries or ask follow-up questions based on the initial results and the natural language responses.

The UI 300 can include a list of filters 340 to allow or prevent certain content items from appearing in the search results 320 (e.g., to prevent items from being referenced in any content references 322 and/or prevent items from being considered as input to generate the natural language response 330). The UI 300 can present options 344 for filtering content items based on attributes such as user(s), author(s), contributor(s), type (e.g., webpage, blog, forum post, document, image, email), time created, time modified, time accessed, team, workspace, and the like. In some implementations, content items from outside the workspace can be accessed through the workspace. The UI 300 can present content source options 342 to filter content based on the source of the content items. The filters 340 can be presented in a sidebar of the UI 300 and/or can be presented via a tabbed interface (e.g., with different tabs corresponding to filter categories, such as user, workspace, content source, and the like).

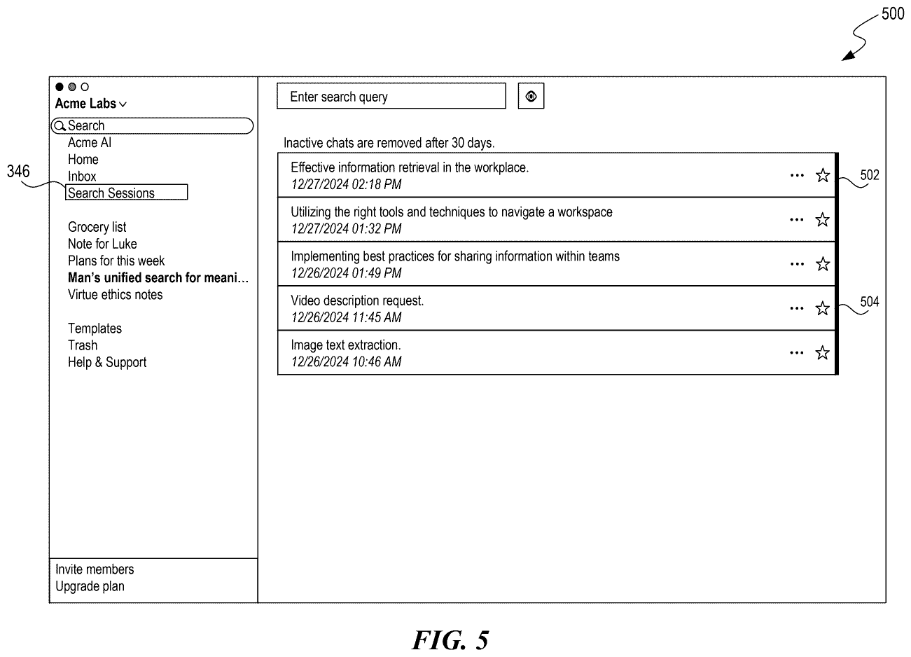

The UI can present a search session indication 346 that can present options for returning to previous search sessions. Accessing multiple search sessions is described in more detail with respect to FIG. 5.

Each content reference 322 can indicate a content item that satisfies the search query and can include information identifying, referencing, or describing the indicated content item. For example, the content reference 322 can include an icon 324 (e.g., identifying a type of content item or a source of the content item), a title 326, and/or a description 328. The description 328 can include text from the content item (e.g., the first lines of a document), a preview of the content item (e.g., a snippet of relevant text), a user-generated description of the content item, an AI-generated summary of the content item (such as a description of an image), or an AI-generated description of the relevance of the content item to the search query. The content reference 322 can further include a link that directs a user to the indicated content item.

The natural language response 330 can be configured to satisfy a search query. For example, the natural language response 330 can summarize list of content references 322 (e.g., the names, sources, authors, etc.), summarize the contents of the content items indicated by the content references 322 (e.g., present summaries of each content item indicated by a content reference 322 or generate a combined summary of all content items indicated by the content references 322), explain the relevance of content items, use the content indicated in the content references 322 to explain and/or answer a question posed in the search query, and/or make suggestions for the user. Such suggestions can include, for example, suggesting further search queries (e.g., to surface more relevant results or learn more about relevant topics) or suggesting actions to take on the content references 322 (e.g., producing a document using the contents of the content items indicated by the content references 322). The natural language response 330 can be generated via an AI model (e.g., an LLM) configured to quickly and/or efficiently generate the natural language response 330 (e.g., a lightweight analysis) and/or be generated via an AI model configured to generate a response that more deeply and/or thoroughly processes the content items. The natural language response 330 can include text specifically referencing a particular content item and include a reference (e.g., an in-line reference and/or a separate citation) to the referenced content item. In some implementations, the reference includes a link 334 to the referenced content item. In some implementations, the UI 300 presents an AI results indication 332, such that an interaction with the indication 332 causes presentation of the natural language response 330. In some implementations, the list of content references 322 becomes smaller, presents fewer content references 322, and/or presents less information (e.g., icon 324, title 326, and/or description 328) to make room on the UI 300 for the natural language response 330.

In some implementations, the UI 300 is configured to present the search results 320 (which can include the search results 304, the content references 306, the search bar 312, the content references 322, the natural language response 330, and/or the chat input field 336) in response to a query received at the search input field 302. The search results 304 and content references 322 can be provided concurrently or sequentially. For example, the UI 300 can be configured to present the search results 304 that dynamically update as a user types a first input into the search input field 302 and further present the search results 320 in response to a second input (e.g., the user pressing the Enter key). In some implementations, the UI 300 forgoes displaying the search results 304 in response to the second input and only displays the search results 320. The same set of content items can be provided for the search results 304 as the search results 320. For example, a system can identify and compile a set of content items that satisfy a search query entered into the search input field 302, present a limited number of search results 304 including content references 306 that indicate some of the content items in the set, and subsequently (e.g., in response to a user pressing the Enter key) present search results 320 including content references 322 that indicate the same content items indicated by the content references 306 along with additional content items from the set.

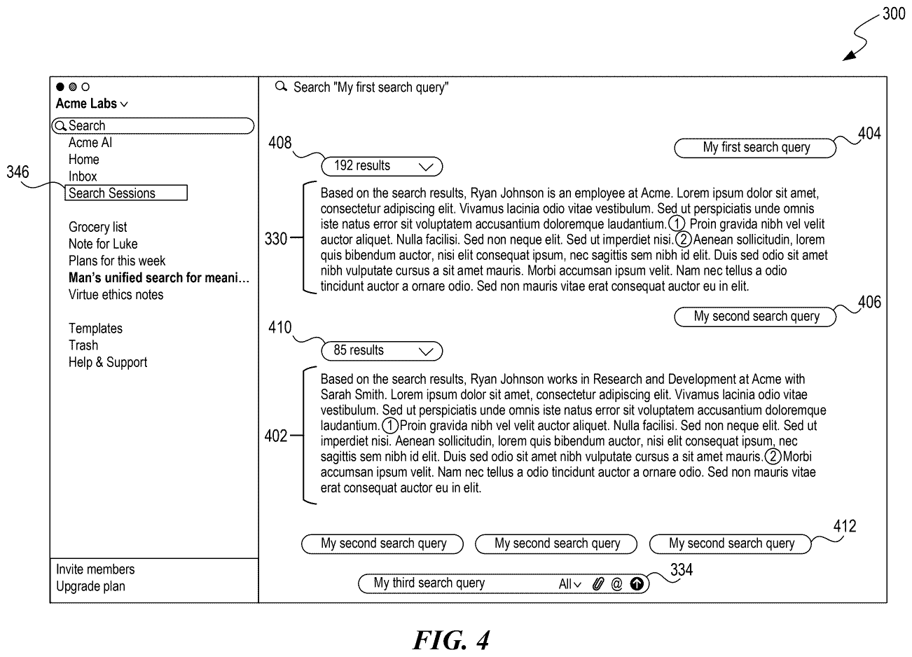

The UI 300 can further include a chat input field 336, configured to receive search queries. The UI 300 can also present suggested search queries 338 that, when selected, are entered into the chat input field 336. In some implementations, the chat input field 336 is configured such that received search queries become part of a chat session with an AI model. The operations of the chat input field 336 are described in more detail with respect to FIG. 4.

FIG. 4 is an illustration of the user interface (UI) 300, configured to display a search-enabled AI chat session. A chat session can include a series of exchanges comprising inputs and responses in which context (such as previous responses and/or search results) is maintained between exchanges in the series. In some implementations, a second search query entered into a chat input field 336 will result in a second natural language response 402. A user can interact with an AI model using the chat input field 336 to receive natural language responses(e.g., second natural language response 402 and/o additional natural language responses), such that the context of the interactions is maintained across interactions. In some implementations, a chat session is initiated when a user enters a search query (e.g., at search input field 302 and/or search bar 312) and the chat session is initialized using the content items that satisfy the search query (e.g., content items indicated by content references 322) to generate a first natural language response (e.g., the natural language response 330) as the first interaction of the chat session. In some implementations, suggested search queries 412 are presented in response to the second natural language response 330 and, when selected, cause the suggested search query 412 to be entered into the chat input field 336.

The UI 300 can be configured to give a chat-like interface, including user inputs 404, 406 (e.g., prompts) and AI-generated natural language responses 330, 402. In some implementations, a user prompt (such as a search query entered into chat input field 336) can result in a system identifying and compiling a set of content items, accessible through the workspace, that satisfy the user prompt. A list of content references indicating these content items can be presented on UI 300 concurrently with chat elements (e.g., the user inputs 404, 406 and/or the natural language responses 330, 402). In some implementations, one or more indications 408, 410 of content references is presented as an interface element, which can include information about the identified content items (such as a total number of content items identified). Indications 408, 410 can each be a condensed or collapsed form of content references, and interacting with the indications 408 or 410 results in a list of content references being displayed on the UI 300 (e.g., between the natural language response 330 and the second natural language response 402). In some implementations, the identified content items can be used in the chat session as input to an AI, and a natural language response (e.g., the natural language responses 330, 402) can be based in part on the identified content items.

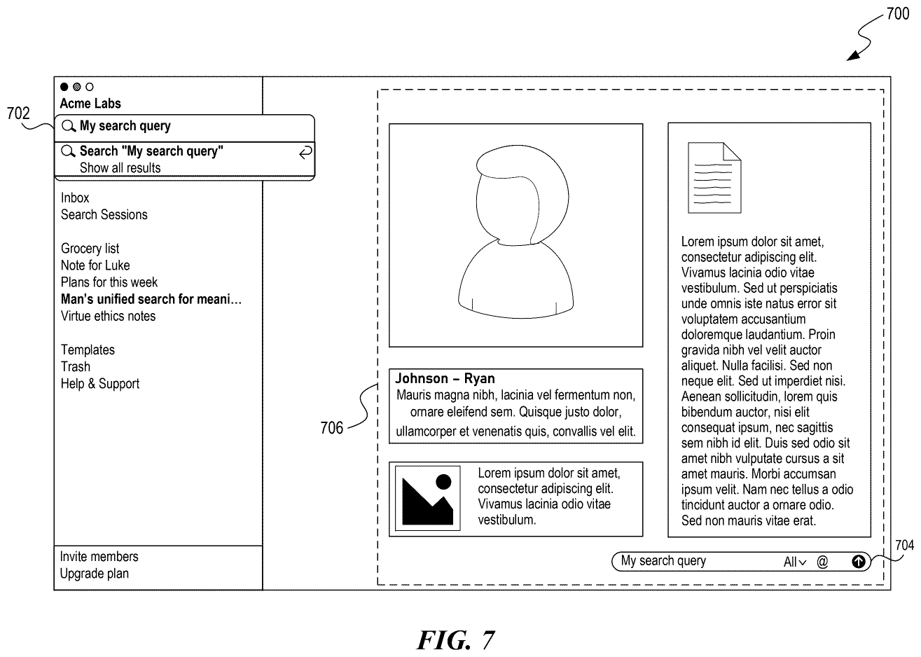

In some implementations, a search query received at search input field 302 and/or search bar 312 will cause presentation of a chat-like interface, presenting search results 320 including the user input 404 (e.g., the search query), the indication 408, and the natural language response 330. The indication 408 can correspond to content references that indicate the same content items as the content references 322 that would be presented without using the chat-like interface. In some implementations, the interacting with the indication 408 causes presentation of the content references 322 in a manner substantially identical to the presentation of search results 320 in FIG. 3B. In some implementations, presenting search results 320 in a chat-like interface is determined by a determined intent of a search query. Determining an intent of a search query is described in more detail with respect to FIG. 7. In some implementations, the presentation of interface elements is determined by the platform that the UI 300 is displayed on. For example, a search field (e.g., search input field 302 and/or search bar 312) can be configured to display a chat-like interface on mobile devices but display a list of content references on other devices. Furthermore, the relative position and size of the elements can be different (for example, fewer content references 322 can be displayed on screens of different sizes).

In some implementations, after receiving a first search query and causing presentation of search results 320, receiving a second search query into the chat input field 336 causes presentation of a chat-like interface appended to the search results. For example, the second natural language response 402 can be presented as a continuation of the search results 320. As shown in FIG. 4, the user input 406 (e.g., the second search query), indicators 410, and second natural language response 402 can be provided adjacent to the search results 320 (e.g., immediately below the content references 322 and the natural language response 330).

In some implementations, when a system receives a search query at the search bar 312 and/or the chat input field 336, the system will not be able to identify any content items that satisfy the search query. Thus, the compiled set of content items will contain zero items, and zero content references will be indicated (e.g., presented as content references 322 and/or indicated by indications 408, 410). In some implementations, when no content references are indicated, a natural language response (e.g., natural language response 330, 402) can indicate that no results have been found and/or present suggestions for improved search queries, and the chat input field 336 can be configured to accept a prompt and/or a new search query.

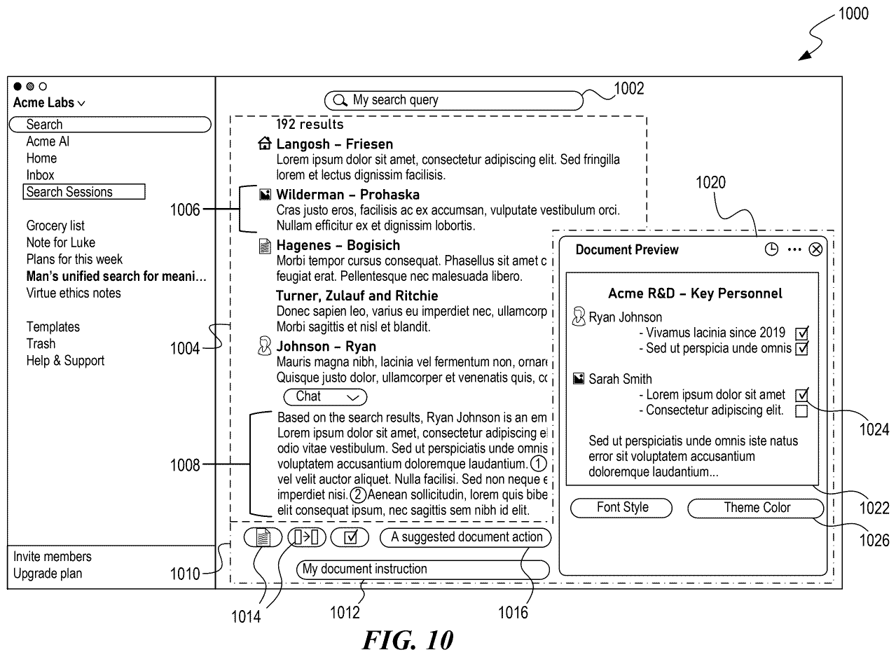

FIG. 5 is an illustration of a user interface (UI) 500 through which multiple active search sessions can be accessed. This UI 500 can be accessed, for example, through an interactive element of the workspace (e.g., an interface element on a sidebar of the UI 300 in FIGS. 3A through 4, such as search session indicator 346). In some implementations, receiving a search query at an input field (e.g., the search input field 302 and/or the search bar 312) initiates a search session. A search session can include the search results (e.g. search results 320, including the list of content references 322), one or more natural language responses (e.g., the natural language response 330, 402), and/or chat-like elements (e.g., indications 408, 410). A system can maintain multiple active search sessions and store search session content, such as the search queries and/or user prompts (e.g., user input 404, 406) and search results. The UI 500 can present interface elements 502, 504 that indicate individual search sessions. When a user selects an interface element 502, 504, the content of the indicated search session (e.g., search results 320, content references 322, natural language responses 330, 402, user inputs 404, 406, and/or indications 408, 410) and one or more input fields (such as the search input field 302, search bar 312, and/or chat input field 336) can be presented to the user. This can give the user the ability to continue the search session and/or chat session. In some implementations, search sessions and/or chat sessions are automatically stored. The storing can be temporary. For example, a session is stored for a predetermined time (e.g., 2 hours or 24 hours) to enable a user to continue working with a recent session. However, after the predetermined time, the system can automatically discontinue the storing in order to avoid cluttering of the active search session UI. In some implementations, search sessions and/or chat sessions are stored, permanently or temporarily, only in response to a user input requesting storage. In some implementations, content created as part of a particular search session (e.g., documents, pages, blocks, and/or processes) can be saved and later presented as part of the search session. Creating content (e.g., documents) as part of a search session is described in more detail with respect to FIG. 10.

In the preceding description, one or more AI systems and/or AI models (e.g., large language models (LLMs) and/or transformers such as transformer 212 described with respect to FIG. 2) can be used to process user input (e.g., search queries), process content items, and/or generate content items (e.g., natural language responses). Any two user inputs can be processed by two sets of AI models that can have models in common or can have no models in common. Similarly, any two generated content items can be generated by two sets of AI models that can have models in common with each other and/or models used to process user input, and/or can have no models in common with each other and/or models used to process user input.

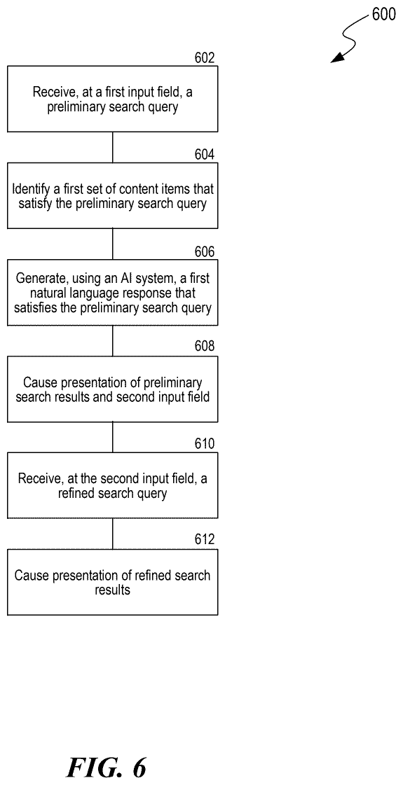

FIG. 6 is a flow diagram illustrating a process 600 for providing an AI-enhanced interactive search of content items accessible via a workspace. The process 600 can be performed by a system (e.g., a computer system 1200 described with respect to FIG. 12) associated with the platform 100 of FIG. 1. The process 600 can include displaying user interfaces such as the user interfaces 300 and 500 described with respect to FIGS. 3A through 5.

At 602, a system can receive, at a first input field (e.g., the search input field 302 in FIG. 3A or the search bar 312 of FIG. 3B), a preliminary search query for content items that are accessible via the workspace. The preliminary search query can be formatted as a keyword search and/or as a natural language prompt. In some implementations, receiving a preliminary search query initiates a first search session.

At 604, the system can identify a first set of content items (e.g., content items corresponding to the content references 306 and/or the content references 322 in FIGS. 3A and 3B) that are accessible from the workspace and that satisfy the preliminary search query. The content items identified can respect user permissions of the workspce (e.g., as defined in an access control list (ACL)). For example, the system can recognize that the preliminary search query has been received via a particular user or user profile that does not have permission to view a particular content item. In response, the system can prevent the particular content item from being included in the first set of content items. In some implementations, the content items in the first set of content items are content items of the workspace and are retrievable from the workspace (e.g., content items from the user application 102 or databases 126, described with respect to FIG. 1). In some implementations, the content items can be one or more of: documents, images, videos, multimedia files, pages, user profiles, emails, and/or blocks conforming to a block data model.

In some implementations, a portion of the content items accessible from the workspace are content items from an external source that is outside of the workspace (e.g., content from the Internet or content from databases outside the workspace). For example, the content items in the first set of content items are content items from an external source that is separate from the workspace and are retrieved, through the workspace, from a source that is outside of the workspace.

At 606, the system can generate, using an artificial intelligence (AI) system, a first natural language response (e.g., the natural language response 330 in FIGS. 3B and 4) that satisfies the preliminary search query. The first natural language response can be generated based on content items that are accessible via the workspace. In some implementations, the first natural language response is generated based on the content items in the first set of content items (e.g., content items corresponding to the content references 306 and/or the content references 322 in FIGS. 3A and 3B).

In some implementations, the system can initialize an AI-enabled chat session using the AI system and initialize the chat session with content items accessible through the workspace (e.g., content items corresponding to the content references 306 and/or 322 in FIGS. 3A and 3B) and/or the preliminary search query. A chat session can include a series of exchanges, comprising inputs and responses (e.g., user input 404 and natural language response 330 and/or user input 406 and natural language response 402 in FIG. 4), in which context (such as previous responses and/or search results) is maintained between exchanges in the series. In some implementations, prior to generating the first natural language response, the system initializes a chat session with the AI system. The system can, as part of the chat session, input the preliminary search query to generate the first natural language response (e.g., natural language response 330 in FIGS. 3B and 4) and/or input the refined search query (e.g., user input 406 as received from chat input field 336 in FIG. 4) to the AI system to generate the second natural language response (e.g., natural language response 402 in FIG. 4).

At 608, the system can cause presentation, on an interface of the workspace (e.g., UI 300 and/or UI 500 of FIGS. 3A through 5), of preliminary search results (e.g., search results 320 of FIG. 3B) and a second input field configured to enable investigation of the preliminary search results (e.g., chat input field 336 of FIGS. 3B and 4). The preliminary search results can include indications of the first set of content items (e.g., an itemized list of search results, such as the list of content references 322 in FIG. 3B) and the first natural language response. In some implementations, the system causes the presentation, on the interface of the workspace, of a list of references to one or more sources of content items (e.g., sources indicated by filter options 342), the content items being accessible via the workspace, where each of the references is selectable through the interface of the workspace, and the preliminary search results only include content items in the first set of content items that are from one or more selected sources. In some implementations, the system embeds links (e.g., the links 334) to particular content items (e.g., from the first set of content items) in the first natural language response that satisfies a particular search result.

In some implementations, the preliminary search results include either indications of a first set of content items (e.g., content items indicated by content references 306 and/or 322 in FIGS. 3A and 3B, respectively) or a first natural language response (e.g., natural language response 330 in FIGS. 3B and 4). In some implementations, the system causes presentation of preliminary search results, including a first natural language response satisfying the preliminary search query (e.g., natural language response 330 in FIGS. 3B and 4), and concurrently causes presentation of an itemized content button (e.g., indication 408 in FIG. 4), where interacting with the itemized content button causes presentation of indications of a first set of content items satisfying the preliminary search query (e.g., content references 322 in FIG. 3B). In some implementations, the system causes presentation of preliminary search results, including a first set of content items satisfying the preliminary search query, and concurrently causes presentation of an AI chat button (e.g., AI results indication 332 of FIG. 3B), where interacting with the AI chat button causes presentation of a first natural language response (e.g., the natural language response 330 in FIGS. 3B and 4) and/or the second input field (e.g., chat input field 336 of FIGS. 3B and 4).

In some implementations, the system does not identify any content items that satisfy the search query, leading to an empty first set containing zero content items (leading, for example, to no content references 306 and/or 322 in the search results 304 and/or 320 of FIGS. 3A and 3B, respectively). The system can generate a first natural language response (e.g., the natural language response 330 of FIGS. 3B and 4) identifying that no content items were found, and cause presentation of the first natural language response and the second input field (e.g., chat input field 336 of FIGS. 3B and 4), configured to receive a new search query. In some implementations, the system initializes an AI-enabled chat session in response to the first set of content items being an empty set and causes presentation of the second input field configured to receive a new search query.

At 610, the system can receive, at the second input field (e.g., chat input field 336 of FIGS. 3B and 4), a refined search query (e.g., user input 406 of FIG. 4). The refined search query can be in a natural language format.

At 612, the system can cause presentation, on the interface of the workspace, of refined search results including indications of a second set of content items (e.g., an itemized list of search results similar to search results 320 of FIG. 3B) and a second natural language response (e.g., natural language response 402 of FIG. 4) that satisfies the refined search query. In some implementations, the second natural language response is based in part on content items in the second set of content items. In some implementations, the system embeds links (e.g., similar to links 334 in natural language response 330 of FIG. 3B) to particular content items (e.g., from the second set of content items) in the second natural language response that satisfies a particular search query.

In some implementations, the refined search results include either the indications of a second set of content items or a second natural language response. In some implementations, the system causes presentation of refined search results, including a second natural language response satisfying the refined search query, and concurrently causes presentation of an itemized content button (e.g., indicator 410 of FIG. 4), where interacting with the itemized content button causes presentation of indications of a second set of content items satisfying the refined search query (e.g., an itemized list of search results similar to search results 320 containing content references 322 in FIG. 3B). In some implementations, the system causes presentation of refined search results, including a second set of content items satisfying the refined search query, and concurrently causes presentation of an AI chat button (e.g., similar to AI results indication 332 in FIG. 3B), where interacting with the AI chat button causes presentation of a second natural language response (e.g., natural language response 402 in FIG. 4).

In some implementations, the system allows a user to maintain multiple active search sessions. For example, the system can receive (e.g., from the first input field and/or a third input field, such as search input field 302 or search bar 312) a second preliminary search query for content items that are accessible via the workspace and initiate a second search session. The system can then cause presentation, on the interface of the workspace, of second preliminary search results (e.g., similar to search results 320 in FIG. 3B) and a fourth input field (e.g., chat input field 336). The second preliminary results can include a third set of content items (e.g., similar to content references 322 in FIG. 3B) and/or a third natural language response (e.g., similar to natural language response 330 in FIG. 3B). The fourth input field can be configured to enable investigation of the second preliminary search results, in an analogous way to the second input field with respect to the first preliminary search results. Furthermore, the system can allow a user to switch between active search sessions and continue to interact with them independently. In some implementations, the first search session (including the second input field, the first set of content items, and/or the first natural language response) and the second search session (including the fourth input field, the third set of content items, and/or the third natural language response) are both accessible via the interface of the workspace. For example, the system could (e.g., during the second search), cause presentation on the interface of the workspace of an interface element (e.g., interface element 502 in FIG. 5) that, when activated, indicates an intent to change search sessions. In response, the system can cause presentation of the first search session, including the first preliminary search results and/or the second input field.

### Intent Disambiguation

In some implementations, the present technology adds intent disambiguation to content searches, such as those described with respect to FIGS. 3A through 5. Intent disambiguation in content search can refer to a process of identifying and interpreting the user's true intent behind a search query and providing search results in accordance with the determined intent. Determination of intent by AI can include distinguishing between multiple possible intents by evaluating contextual clues, user history, and specific keywords/phrases within the input. The system can use AI models and probabilistic methods to assign confidence scores to each potential intent and rank the potential intents based on the given context.

Specifically, the intent can have an impact on the format or style of the search results and/or on what components of the search results are displayed (e.g., a list of content items, an AI-generated natural language response, a chat discussion, or a combination thereof). Such intent disambiguation can be important for providing relevant and precise search results, especially when the query itself is ambiguous (e.g., could have multiple meanings or could be answered in multiple ways). As an example, if the system determines that the user's intent with respect to a query is to identify and access content items including content associated with the query, the system can provide a list of content items that include content associated with the query (e.g., the list of content references 306 and/or 322 in FIGS. 3A and 3B, respectively). If the system determines that the user's intent with respect to the query is to receive a natural language response, the system can provide an AI-generated natural language response (e.g., natural language response 330 and/or indication 408 of FIGS. 3B and 4). Further, in some implementations, the system can generate a response that includes both elements(e.g., a list of content items and a natural language response) and presents both elements while emphasizing the element that corresponds to the determined intent more closely (e.g., has a higher confidence score).

FIG. 7 is an illustration of a user interface (UI) 700 including multiple input fields that can determine the context of a search query. The UI 700 can be displayed on a display of an electronic device (e.g., a computer system 1200 described with respect to FIG. 12). The UI 700 can include a first input field 702 and a second input field 704. In some implementations, the first input field 702 corresponds to the input field 302 described with respect to FIGS. 3A and 3B. As shown, the first input field 702 is positioned in a sidebar region of the UI 700. The sidebar region can be configured to provide a user with interface elements that allow a user to navigate and access content of the workspace easily. In some implementations, the second input field 704 corresponds to the input field 336 described with respect to FIG. 4. The second input field 704 is positioned on a page 706 of the UI 700 (e.g., the second input field 704 is embedded on the page 706).

Similar to the description with respect to the input fields 302 and 336, the first input field 702 and second input field 704 can be configured to receive a user search query and present search results, including an itemized list of references to content items accessible through the workspace and/or a natural language result generated by an artificial intelligence (AI) system. The AI system can be, for example, a machine learning (ML) model and/or a large language model (LLM) (e.g., models incorporating a transformer 212 described with respect to FIG. 2).

In some implementations, a system determines an intent of the search query. The intent can be determined based on processing the search query and/or the input field that the search query is received from (e.g., a location of the input field on the UI 700). The system can generate a response having a response format corresponding to the intent of the search query.

The processing of the search query can include determining whether the search query includes one or more key terms or key phrases or whether the search query includes a natural language phrase (e.g., a question). An example of a search query including a key phrase can be “Team A monthly meeting agenda.” The system can determine that an intent of such query is to find a document on the workspace that includes the meeting agenda for Team A's monthly meeting. The response to such a query can include links to pages that include Team A's monthly meeting agendas. In contrast, an example of a search query including a natural language phase (such as a question) can be “What was decided in Team A's monthly meeting?” or “What is Team A focusing on this month?” The system can determine that an intent of such query is to receive an AI-generated response that provides an answer to the question generated using content from the workspace, including the pages that include Team A's monthly meeting agendas.

The intent of the search query can also be determined based on the input field that the search query is received from. Specifically, the system can determine whether a user input the search query on a location that is generally associated with quick content searches, navigation, and access (e.g., a sidebar) or on a location that is generally associated with a chat session (e.g., a bottom corner of a page). The location can provide an indication on the format of search results the user is expecting to receive.

For example, if the system determines that the intent of a search query is to prioritize itemized content (e.g., to identify content items accessible through the workspace that satisfy the search query), then the UI 700 can present references to content items while de-emphasizing a natural language response. For example, the UI 700 can present search results similar to search results 320 in FIG. 3B, containing content references 322 and the natural language response 330, but presenting the natural language response in a region of the UI 700 that is smaller than the region that presents the references to content items, or precluding and/or omitting the natural language response from presentation. Alternatively, or additionally, if the system determines that the intent of a search query is to prioritize generated content (e.g., receive generated content including a natural language response that satisfies the search query), then the UI 700 can present references to a natural language response while de-emphasizing references to content items (e.g., presenting references to content items in a smaller region of the UI 700 than the natural language response or precluding and/or omitting references to content items from presentation).

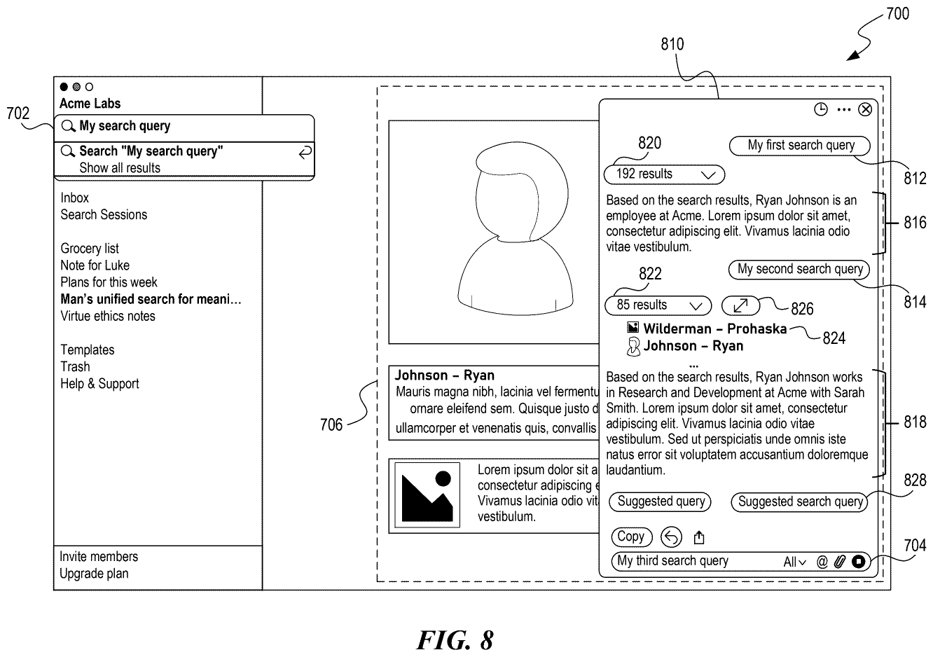

FIG. 8 is an illustration of a user interface (UI) 700 including a chat-like interface for exploring content accessible through a workspace. The UI 700 can include the second input field 704. As shown, the second input field 704 is located in a bottom corner of the page 706 on the UI 700, which can be generally a location that is associated with chat sessions. In some implementations, receiving a search query at the second input field 704 can initiate a chat session. A chat session can include a series of exchanges comprising inputs and responses in which context (such as previous responses and/or search results) is maintained between exchanges in the series. The UI 700 can include a chat window 810 that is configured to present past user search queries 812, 814 and AI-generated natural language responses 816, 818 that satisfy the search queries. In some implementations, the chat window 810 of UI 700 can present references to content items accessible through the workspace that satisfy a search query. This can be presented in a condensed or collapsed view through interface elements 820, 822. The elements 820, 822 can include summary information, such as the number of content items. The elements 820, 822 can be interactive.

In some implementations, interacting with an interface element 820, 822 causes presentation of references to content items that satisfy a search query. For example, interacting with the element 820 can cause presentation of a limited number of content references 824 to content items to appear inside of the chat window 810. The content references 824 can include interactive elements, such as a link that redirects to the content item referenced by the content reference 824. In some implementations, the references 824 are presented with further interactive elements 826 that cause the presentation of more references. For example, interacting with element 826 (or, in some implementations, interface elements 820, 822) can cause presentation of a full list of references to content items, such as the list of content references 322 of UI 300 in FIG. 3B. In some implementations, the content items indicated by the content references 824 and indicated by the interface elements 820, 822 are identical to the content items indicated by the content references 322 in FIG. 3B (e.g., when the same search query is entered into the second input field 704 as search bar 312 and/or search input field 302 in FIG. 3A). In some implementations, interacting with the interface elements 820, 822 can lead to a chat-like interface, such as the layout of UI 300 described with respect to FIG. 4, (e.g., such that the natural language responses 816, 818 can be presented as natural language responses 330, 402, and the user search queries 812, 814 can be presented as user inputs 404, 406). In some implementations, suggested search queries 828 are presented in the chat window 810 and, when selected, cause the suggested search query 828 to be entered into the second input field 704.

In the preceding description, one or more AI systems and/or AI models (e.g., large language models (LLMs) and/or transformers such as transformer 212 described with respect to FIG. 2) can be used to process user input (e.g., search queries, chat input), process content items, and/or generate content items (e.g., natural language responses). Any two user inputs can be processed by two sets of AI models that can have models in common or can have no models in common. Similarly, any two generated content items can be generated by two sets of AI models that can have models in common with each other and/or models used to process user input, and/or can have no models in common with each other and/or models used to process user input. Any such AI models can be generic or general-purpose models (e.g., foundational models) and/or be models configured for a particular purpose (e.g., fine-tuned models).

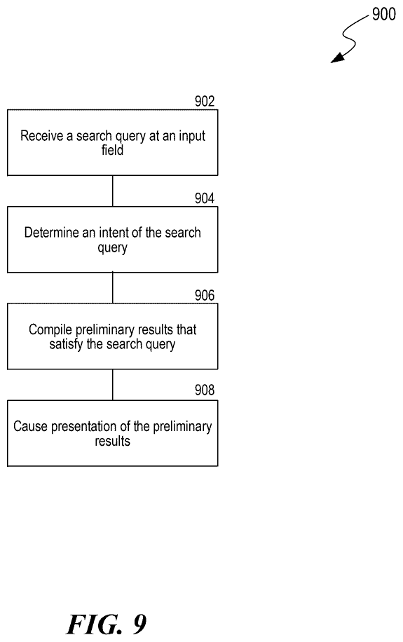

FIG. 9 is a flow diagram illustrating a process 900 for providing an intent-aware AI-enhanced interactive search of content items accessible via a workspace. The workspace can be part of a platform (e.g., platform 100 described with respect to FIG. 1) and/or can implement a block data model. The workspace can contain a collection of content items, such as documents, images, emails, webpages, and/or blocks of a block data model. The process 900 can be performed by a system (e.g., a computer system 1200 described with respect to FIG. 12). The process 900 can include displaying a user interface (UI) such as the user interfaces 300, 500, and 700 described with respect to FIGS. 3A through 8.

At 902, the system receives, at an input field on a user interface, a search query. The input field can be part of a user interface of the workspace, such as the first input field 702, the second input field 704 in FIGS. 7 and 8, the search input field 302 in FIGS. 3A and 3B, the search bar 312 in FIG. 3B, and/or the chat input field 336 in FIGS. 3B and 4. Alternatively, or additionally, the input field can be part of a user interface that can search or connect to one or more workspaces without opening the workspaces in the foreground of a display. The search query can be in any format, including a keyword search format (e.g., a list of words without an apparent grammatical structure or punctuation) or a natural language format (i.e., a question or statement that follows grammatical structure, with or without punctuation). In some implementations, the system uses natural language processing to identify words of the query to determine whether the format of the query is the keyword search format or a natural language format or a combination thereof.

At 904, the system determines an intent of the search query based on processing the content of the search query and/or identifying an input field of a plurality of input fields on the user interface that received the search query. In some implementations, the system processes the search query to determine the intent. The processing can include determining whether the format of the search query includes one or more keywords or key phrases or a natural language phase (e.g., a question or a statement). For example, if the system determines that the search query is in a keyword search format, it can determine that the intent of the search query is to prioritize itemized content (e.g., identify content items accessible through the workspace that satisfy the search query and/or present a list of content references, such as content references 824 in FIG. 8, content references 306 in FIG. 3A, and/or content references 322 in FIG. 3B). Additionally, or alternatively, if the system determines that the search query is in a natural language format (e.g., by detecting grammatical structure, punctuation, capitalization, and/or query words such as “what,” “how,” or “why”), the system can determine that the intent of the search query is to prioritize generated content (e.g., to receive generated content including a natural language response to the search query, such as natural language responses 816, 818 in FIG. 8, natural language response 330 in FIGS. 3A and 3B, and/or natural language response 402 in FIG. 4).

In some implementations, the system presents (e.g., concurrently on a UI) a first input field and a second input field. The first input field can be at a first location and the second input field can be at a second location. In various examples, the first input field can be on a page (e.g., the search bar 312 in FIG. 3B) or on a sidebar (e.g., the search input field 302 in FIGS. 3A and 3B or the first input field 702 in FIGS. 7 and 8). The second input field can be on a page (e.g., the chat input field 336 in FIGS. 3B and 4) and/or in a corner (e.g., the second input field 704, as depicted in FIG. 7), or in a chat window (e.g., the second input field 704, as depicted in chat window 810 in FIG. 8). The system can determine an intent of the search query based on identifying the input field that received the search query. In some implementations, the system identifies that the first input field received the search query and determines that the intent of the search query is to prioritize itemized content. In some implementations, system identifies that the second input field received the search query and determines that the intent of the search query is to prioritize generated content.

In some implementations, determining the intent includes assigning confidence scores (e.g., values ranging from 0 to 1) for the different types of formats and comparing the confidence scores to identify the most likely intent of the search query. The system can assign a first confidence score for the search query being a natural language question and a second confidence score for the search query being a keyword/keyphrase format query. The system then compares the first and second confidence score to determine what is the intent of the search query. For example, in an instance that the first confidence score is 0.9 and the second confidence score is 0.3, the system can determine that the search query has an intent of being a natural language question. However, in some instances the first and second confidence scores can be similar to each other. In such instances, the system determines that the intent can be of either type or of both types (e.g., the user's intent is to see both itemized content and generated content).

In some implementations, a first input field and a second input field are both configured to, in response to receiving a search query, perform a search for content items (e.g., content items accessible through a workspace, such as content items indicated by content references 824 in FIG. 8, content references 306 in FIG. 3A, and/or content references 322 in FIG. 3B, including content items of the workspace and content items from third-party or external sources such as web content) that satisfy the search query and/or generate a natural language response (e.g., natural language responses 816, 818 in FIG. 8, natural language response 330 in FIGS. 3A and 3B, and/or natural language response 402 in FIG. 4) to the search query. The two input fields can be configured to perform the same action in response to receiving a search query while being configured to determine a different intent for the search query, which can, for example, lead to different presentations of search results. For instance, the first input field can be weighted to prioritize (e.g., emphasize) reference to content items that satisfy a received search query, and in response to receiving a search query, can cause presentation of search results that are weighted to prioritize references to content items (e.g., by causing presentation of references to content items while de-emphasizing a natural language response). One example would include presenting search results similar to search results 320 in FIG. 3B (e.g., containing content references 322 and the natural language response 330) but presenting the natural language response in a region that is smaller than the region in which the content references are presented or precluding and/or omitting the natural language response from presentation. Similarly, the second input field can be weighted to prioritize generated content that satisfies a received search query and, in response to receiving a search query, can cause presentation of search results that are weighted to prioritize a natural language response that is generated using an artificial intelligence (AI) system (e.g., by causing presentation of a natural language response while de-emphasizing references to content items). One example of this would be presenting references to content items in a smaller region than the natural language response or precluding and/or omitting references to content items from presentation.

At 906, the system compiles preliminary results that satisfy the search query. The preliminary results can include a set of content items that satisfy the search query (e.g., the content items indicated by the interface element 820, by the content references 306 in FIG. 3A, and/or by the content references 322 in FIG. 3B), and a natural language response to the search query (e.g., natural language response 816 and/or natural language response 330 in FIGS. 3A and 3B). The system can compile a set of content items accessible through the workspace that satisfies the search query and can generate a natural language response that satisfies the search query. In some implementations, the natural language response is generated as output of a generative artificial intelligence (AI) system based at least in part on input including the set of content items that satisfy the search query.

At 908, the system causes presentation, on an interface of the workspace (e.g., UI 700 of FIGS. 7 and 8, UI 300 of FIGS. 3A through 4, and/or UI 500 of FIG. 5), of the preliminary results. The representations of content items and/or the natural language response can contain links to referenced content items (e.g., links 334 in FIG. 3B). For example, a natural language response can reference a particular content item and present an interactive element that functions as a link to the referenced content item.

In some implementations, the representations of the preliminary results which are presented are configured to prioritize either references to content items in the set of content items or the natural language response. The prioritization can be based on the determined intent of the search query. In some implementations, the system determines that the intent of a search query is to include both itemized content and generated content and causes presentation of preliminary results including (i) references to content items in the first set of content items that satisfy the search query and (ii) the natural language response to the search query. Additionally, the system can configure the relative size between the references to content items and the natural language response based on the determined intent of the search query. For example, the intent of the search query can further be to emphasize generated content (e.g., by receiving the search query at an input field configured to prioritize itemized content but in a format indicating an intent to prioritize generated content, or vice versa), and thus the system can cause the relative size of the natural language response (e.g., the size of a display dedicated to presenting the generated content) to be larger than the references to content items. Additionally, or alternatively, the intent of the search query can further be to emphasize itemized content, and thus the system can cause the relative size of the itemized content to be larger than the natural language response. In some implementations, the presentation of the preliminary results and/or the natural language response can depend on the content therein. For example, the system could prioritize the natural language response if it is determined (e.g., based on the intent of the search query) that the natural language response addresses the search more fully than the preliminary results.

In some implementations, the system determines that the intent of a search query is to prioritize itemized content and/or determines that a first input field received the search query and causes presentation of preliminary results such that the natural language response to the search query is de-emphasized. In some implementations, the system determines that the intent of a search query is to prioritize generated content and/or determines that a second input field received the search query and causes presentation of preliminary results such that the references to content items that satisfy the search query are de-emphasized. In some implementations, de-emphasized content items are represented by an interface element (e.g., AI results indication 332 in FIG. 3B, indications 408, 410 in FIG. 4, and/or interface elements 820, 822) that can contain summary information (e.g., total number of content items identified). Interacting with the interface element can cause presentation of more detailed information, such as references to content items. The system can cause presentation of a limited number of references in response to a first interaction, and a larger number of references in response to a second interaction.

As an example, prioritizing a type of search result can include displaying prioritized search results at the top of the page or using a visual emphasis (e.g., highlight, bolding, larger size, or other visual indication), while de-emphasizing can include displaying de-emphasized search results at the bottom of the page or using visual de-emphasis (e.g., smaller font), or providing the de-emphasized search results only via a selectable interface element (e.g., a user can click on a drop-down menu to review the de-emphasized search results).

In some implementations, the search query and natural language response are an exchange of an AI-enabled chat session. For example, the system can initiate a chat session and cause presentation of an input field (e.g., search input field 302 in FIG. 3A, search bar 312 in FIG. 3B, chat input field 336 in FIGS. 3B and 4, the first input field 702 in FIGS. 7 and 8, and/or the second input field 704 in FIGS. 7 and 8) configured to receive a prompt to interact with a chatbot (e.g., an AI model configured to interact in the form of a conversation). In some implementations, the system causes presentation of an input field of a chatbot configured to enable exploration of search results (e.g., content items and/or a natural language response satisfying the search query, such as search results 304 in FIG. 3A and/or search results 320 in FIG. 3B). The system receives an additional search query in a natural language format at the input field and initiates a chat session. The system can perform another search, resulting in additional content items and an additional natural language response satisfying the additional search query, and can present updated results, which can include an additional reference to a content item that satisfies the additional search query and/or the additional natural language response to the additional search query. In some implementations, the chat session is initiated in response to a separate user action. For example, after causing presentation of references to a first set of content items that satisfy a first search query and a natural language response to the first search query, the chat session can be initiated in response to the system receiving a second search query. The system can include the first natural language response in a chat window containing the first and second search queries with additional natural language responses and/or references to content items.

### Find to Create Flow

In some implementations, the present technology adds document generation capabilities to content searches, such as those described with respect to FIGS. 3A through 8. Document generation (or content generation) in content search can refer to a process of using, in part, the results of a content search to generate an electronic document. The document can be hosted on the workspace (e.g., embedded in a webpage) and/or can be downloaded. The document can be one of many file types, including text (such as text files, Markdown files, Microsoft Word document (.docx) files, and the like), PDF, image (PNG, JPG, WebP), video (MP4, AVI), audio, an email (e.g., with recipient email addresses, embedded files, and/or attachments), a webpage (e.g., one or more files, such as HTML, CSS, and/or JavaScript files, that are hosted by the workspace and presented on a user interface), and/or a workflow (e.g., a job tracker, a schedule, a calendar reminder). The document can be created in response to a user input (e.g., interacting with an interface element, inputting a natural language command), and can contain content, including generated content (e.g., a summary of content items, a to-do list generated based on content items), that is specified by the user input.

FIG. 10 illustrates a user interface (UI) 1000 for generating documents including content based on search results in a workspace. The UI 1000 can be displayed on a display of an electronic device (e.g., a computer system 1200 described with respect to FIG. 12) and can display content items that are accessible through a workspace (e.g., part of platform 100 in FIG. 1). The UI 1000 can include a search input field where users can enter search queries for content items accessible via the workspace. The system can compile and display search results satisfying the search query on the interface. The UI 1000 can additionally present a document creation interface and/or interactive elements allowing a user to create a document and/or workspace website based on the results of the search. The UI 1000 can also allow documents to be created in response to a command entered at an input field.

In some implementations, the UI 1000 can present an input field 1002 configured to initiate a search and display a list of search results. The input field 1002 can be configured similarly to search input field 302 in FIG. 3A (e.g., positioned on a sidebar and/or configured to present quick results to search queries), search bar 312 in FIG. 3B (e.g., positioned on a page and/or configured to present a detailed list of content references and/or a natural language response), and/or the second input field 704 in FIGS. 7 and 8 (e.g., positioned on a page, in a corner, and/or in a chat window and/or configured to present a chat-like interface with indications of content items and/or natural language responses). The UI 1000 can present search results 1004 including content references 1006 to content items that satisfy the search query and/or a natural language response 1008. The content references 1006 identify content items that are accessible via the workspace and can include items stored within the workspace itself or retrieved from external sources. The natural language response 1008 can be generated based on input that includes the content items satisfying the search query.

The UI 1000 can also feature a document generation interface 1010 for creating and/or displaying generated documents. This interface can include a document generation input field 1012 where users can enter instructions for generating a document based on the search results. The instructions can be in natural language format, allowing users to specify their requirements in a conversational manner. In some implementations, properties of the generated document (e.g., type, content, location in the workspace) can be defined by the user in a natural language format via input into the document generation input field 1012. The generated document can include content that is created by an AI system, synthesizing information from the search results into a coherent document that satisfies the document generation instructions. For example, the generated document can include natural language content and/or excerpts from content items satisfying a search query, formatted according to the document generation instructions. The specified formatting can include, text size, colors, title, images, graphs, tables, positions (e.g., of text, title, images, and the like), document length, and the like In another example, the generated document can have embedded content items (e.g., include an image from the search results, an image specified and/or uploaded by a user, and/or documents embedded as attachments for viewing/downloading).

The document generation interface 1010 and/or elements of the document generation interface 1010 can overlap with other elements or regions of the UI 1000. In some implementations, the document generation input field 1012 can also be configured to present further search results (e.g., similar to and/or overlapping in function with chat input field 336 in FIG. 3B and/or the second input field 704 in FIGS. 7 and 8). For example, the system can determine whether to present an updated list of search results or generate a document based on an analysis of the input (e.g., action words such as “make,” “generate,” or “create” can lead to document generation, while other phrases or questions result in search results). In some implementations, entering a document generation instruction to an input field (e.g., search input field 302 in FIG. 3A, search bar 312 in FIG. 3B, first input field 702 in FIGS. 7 and 8, and/or second input field 704 in FIGS. 7 and 8) will cause the generation of a document based on search results without presenting the search results (e.g., only presenting the generated document).

The document generation interface 1010 can also include one or more document generation interface elements 1014. These elements can be selectable options associated with different document types or formats, enabling users to quickly specify properties and/or attributes of a generated document. In some implementations, a document generation interface element is associated with a particular document generation action (e.g., a button that summarizes search result content into a document). In some implementations, multiple document generation interface elements 1014 are presented, and each is associated with creating a document of a corresponding type (e.g., a document generation instruction with specific parameters). The document type can include file format (e.g., text file, slide show, image, spreadsheet, email, reply/comment, table, chart, webpage) and/or content format (e.g., memo, list, news article, blog post, schedule, calendar, job tracker). In some implementations, a document generation interface element 1014 is associated with a particular digital location in which a generated document will be saved. For example, the document generation interface element 1014 can include a menu representing a file tree and/or directory structure that determines the save location of a generated document. The document generation instruction can be incomplete, requiring further instruction (e.g., a button to generate a text document that additionally requires a user input to describe content, format, and the like) or complete (e.g., the document generation instruction can individually result in document generation, and could be assisted by additional instructions). Additionally, or alternatively, the document generation interface 1010 can include one or more drop-down style menus, checkboxes, and/or radio buttons that can be used to define and specify a document type, content, and/or save location. These options can be incorporated into a document generation instruction (e.g., a natural language generation instruction received through document generation input field 1012 and/or through a selection of one of the document generation interface elements 1014). In some implementations, the document generation interface elements 1014 are presented after a document has been generated to further modify the generated document (e.g., to convert a file format and/or to change a save location).

In some implementations, the interface elements 1014 cause a natural language document generation instruction to be transmitted to the system (e.g., received at as input into document generation input field 1012). In some implementations, suggested actions 1016 (e.g., presented along with suggested search queries, such as suggested search queries 338 in FIG. 3B) are presented indicating a document generation instruction, and interacting with a suggested action 1016 causes the indicated document generation instruction to be issued to the system. In some implementations, suggested actions 1016 indicate a natural language document generation instruction, and interacting with a suggested action 1016 causes the indicated natural language document generation instruction to be issued to the system (e.g., entered into document generation input field 1012).

When the system receives an instruction to generate a document, it can process this instruction along with at least a portion of the search results. The portion used can include the content items referenced in the search results, the natural language response, or both, depending on the document generation instruction. For example, an instruction can include “use only the top three results,” which can cause the content items referenced by the top three content references 1006 to be included in the generated document. In another example, an instruction can include “include any pages by User 1,” which can cause content items created by User 1 and/or portions of the natural language response directed to content created by User 1 to be included in the generated document. In another example, an instruction can include “create a summary of User 1, and include a profile picture,” which can cause content items about User 1 and/or portions of the natural language response about User 1 to be included in the generated document and can cause a picture of User 1 to be embedded into the generated document. In another example, content items presented in the search results 1004 can be selectable (e.g., the UI 1000 can include selectable interface elements, such as checkboxes, to identify certain content references and/or the natural language response 1008), and only those selected content items can be included in the document. In some implementations, a list of filter options (e.g., similar to filters 340 in FIG. 3B, including options 344 and content source options 342) can be presented to filter the search results 1004 (e.g., by content type and/or source). The content references 1006, natural language response 1008, and any documents created through the document generation interface 1010 can include content from only the content items specified by the filter options.

The system can then generate a document based on the instruction and the selected portion of the search results. The generated document can be displayed within the UI 1000. For example, the UI 1000 can present a document preview window 1020, including a document preview 1022. In some implementations, the document preview window 1020 (and/or the document generation interface 1010) has an interactive element to allow users to download, post, and/or share the generated document. In some implementations, the generated document becomes a content item of the workspace (e.g., a page or a document embedded in a page). In some implementations, a user can directly edit a generated document using the document preview 1022. For example, a preview of a text document can allow a user to directly edit text, and/or can include a toolbar for changing font type, size, and color options, indents, inserting links, and the like. In another example, a preview of an image document can include tools to change color, crop, or cut and paste sections of the image. In another example, a preview of an email document can include tools to change the title, recipient address(es), or attachments. The generated document can also feature dynamic elements 1024, which can be interactable (e.g., a selectable checkbox, a drop-down menu),

In some implementations, the document preview window 1020 presents its own document generation interface, through which users can refine or alter generated documents. For instance, the document preview window 1020 can include one or more format option elements 1026, which can change aspects of the generated document (e.g., formatting, size, style type). The format option elements 1026 can be generated automatically based on the user input and document type, and/or can be predetermined. In some implementations, the format option elements 1026 generate a new document (e.g., issue to the system the original document generation instruction with additional parameters specified by the format option element 1026). The document preview window 1020 can also present another input field for users to input natural language instructions for modifying a document.

In some implementations, the document preview window 1020 is presented as the content of a page of the workspace (e.g., similar to page content 308 in FIG. 3A or page 706 in FIGS. 7 and 8, in which the content fills the majority of the UI). In some implementations, the document preview window 1020 fills a portion of the UI 1000, allowing other page content (e.g., search results, such as search results 1004 and/or search results 320 in FIG. 3B; filter options, such as filters 340 in FIG. 3B; document generation interface 1010; page content, such as page content 308 in FIG. 3A; one or more input fields, such as search input field 302 in 3A, search bar 312 in 3B, chat input field 336 in FIGS. 3A and 4, first input field 702 in FIGS. 7 and 8, and/or second input field 704 in FIGS. 7 and 8; and/or a chat window, such as chat window 810 in FIG. 8) to be presented simultaneously. For example, the document preview window 1020 can be positioned to one side of the UI 1000 (e.g., with other page content on the other side), as a floating window (e.g., as a component of the UI 1000 that can be moved, resized, minimized, and/or closed independently), and/or as a new tab of the workspace (e.g., one of a plurality of tabs presented on the UI 1000). In some implementations, the document preview window 1020 can be presented in a separate browser environment (e.g., as a new window or tab of a web browser).

Some dynamic elements 1024 can dynamically reflect attributes of the workspace or other relevant data sources. This can include content from content items in the workspace or data about collections of content items in the workspace (e.g., the number of pages created by a particular user). In some implementations, the generated document is hosted on the workspace (e.g., the document can be a page, or can be embedded in a page). A dynamic element 1024 can display a value (e.g., the current number of users in the workspace). This value can be updated automatically (e.g., at regular intervals) and/or when a user accesses the document. In some implementations, the generated document can reference workspace content (e.g., the title of a page). The referenced content can be dynamic/updating (e.g., updating when the title changes) or static. The dynamic elements 1024 can represent collections of data. For example, a dynamic element 1024 can include visualizations such as a table, graph, flow chart, and the like.

The system can generate a variety of document types. While FIG. 10 illustrates a generated text document, the system can also create other types of content items or workflow structures (e.g., schedules and/or trackers). In some implementations, the UI 1000 can present a workflow structure generation interface (e.g., similar or identical to the document generation interface 1010).

In one example, the generated document can be hosted on the workspace (e.g., being a page, or embedded in a page) and/or shared with other uses of the workspace. Dynamic elements 1024 can be linked to certain content and/or data of the workspace (e.g., total number of users, last active time of a number of users). The dynamic elements 1024 can be updated automatically, e.g. at regular intervals and/or when a user accesses the document.

In another example, the generated document can include trackers (e.g., task or job trackers) where tasks are organized in a hierarchical structure (e.g., project, task, sub-task). This can include a list of tasks that are assigned to different users, progress indicators for tasks, and descriptions and/or comments relating to each task. For example, the tracker can be generated in part from a projects template 112 and/or meeting and calendar template 114 described with respect to FIG. 1. These can be represented by dynamic elements 1024 and can be synchronized between all users of the document. Generated trackers can include dynamic elements, allowing users to update task statuses or other relevant information directly within the tracker.

In another example, the generated document can include schedules where tasks or activities are arranged in a temporal order. These tasks can have dates associated with making progress or completing the task and can be presented in order of associated date. For instance, a generated schedule can be added to a calendar associated with the workspace. The generated schedule can include, for example, reminders, to-do lists, scheduled meetings, etc. The schedule can be associated with and/or generated in part from a meeting and calendar template 114 described with respect to FIG. 1. Generated schedules can include dynamic elements, allowing users to update task statuses or other relevant information directly within the schedule.

In some implementations, the generated document can include an email including, e.g., content, attachments, and recipient email address. In some implementations, email content is generated by an AI system based on document generation instructions. The generated email can have (e.g., as part of document preview window 1020) options to send, save as draft, or discard.

In some implementations, the file type and/or format of a document is determined by the system (e.g., tailored for a specific purpose). For example, an input of “summarize these results into an action plan” can generate a memo, poster, a schedule with relevant tasks and dates, or a job tracker with relevant tasks. The system can use context (e.g., content of the workspace and/or previous inputs and/or search results) to determine a file type and format.

In some implementations, the generated document is part of a chat session with an AI system. For example, the document generation input field 1012 can coincide with chat input field 336 in FIGS. 3A and 4 and/or the second input field 704 in FIGS. 7 and 8, and a user can enter a document generation instruction as part of a chat session. This allows the benefits described with respect to FIGS. 3B, 4, 7, and 8 to apply to generated documents. For example, a generated document can be incorporated into a search session, which a user can return to (e.g., through interface elements 502, 504 in FIG. 5, each indicating individual search sessions). Additionally, or alternatively, the system can include context (e.g., past interactions and results, such as: search results 304 in FIG. 3A; search results 320 in FIG. 3B; user inputs 404, 406, content items corresponding to indications, 410, and natural language responses 330, 402 in FIG. 4; user search queries 812, 814, content indicated by interface elements 820, 822, and/or natural language responses 816, 818 in FIG. 8) when generating documents (e.g., deciding file type and/or format, content items used to generate the document, style or type of content presented in the document, dynamic elements included, and the like). If multiple documents are generated as part of a search session, they can all be saved and associated with the search session.

In the preceding description, one or more AI systems and/or AI models (e.g., large language models (LLMs) and/or transformers such as transformer 212 described with respect to FIG. 2) can be used to process user input (e.g., search queries, document generation instructions), process content items, and/or generate content items (e.g., natural language responses and/or generated documents). Any two user inputs can be processed by two sets of AI models that can have models in common or can have no models in common. Similarly, any two generated content items can be generated by two sets of AI models that can have models in common with each other and/or models used to process user input and/or can have no models in common with each other and/or models used to process user input.

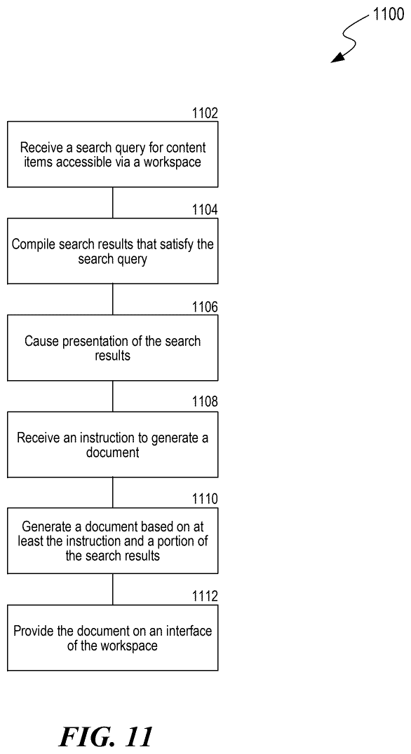

FIG. 11 is a flow diagram illustrating a process 1100 for generating a document based on the surfaced content items from a search. The process 1100 can be performed by a system (e.g., a computer system 1200 described with respect to FIG. 12). The process 1100 can include displaying a user interface (UI) such as the user interfaces 300, 500, 700, and 1000 described with respect to FIGS. 3A through 10.

At 1102, the system can receive, on an interface of a workspace (e.g., at input field 1002 and/or document generation input field 1012 of UI 1000 in FIG. 10, the search input field 302 in FIGS. 3A and 3B, the search bar 312 in FIG. 3B, the chat input field 336 in FIGS. 3B and 4, the first input field 702, and/or the second input field 704 in FIGS. 7 and 8), a search query for content items accessible via the workspace.

At 1104, the system can compile search results (e.g., search results 304 in FIG. 3A, search results 320 in FIG. 3B) that satisfy the search query. The search results can include references to content items that satisfy the search query (e.g., content items accessible via the workspace, which can be included in the workspace and/or be accessed from a source outside of the workspace, such as: content items indicated by content references 1006 in FIG. 10; indicated by content references 322 in FIG. 3B; indicated by indications 408, 410 in FIG. 4; and/or indicated by interface elements 820, 822 in FIG. 8), and/or a natural language response to the search query (e.g., natural language response 1008 in FIG. 10, natural language response 330 in FIGS. 3B and 4, natural language response 402 in FIG. 4, and/or natural language responses 816, 818 in FIG. 8). The natural language response can be generated as output of a generative artificial intelligence (AI) system and can be based at least in part on input including the content items that satisfy the search query.

At 1106, the system can cause presentation, on an interface of the workspace (e.g., UI 300 in FIGS. 3A, 3B, and 4; UI 500 in FIG. 5; UI 700 in FIGS. 7 and 8; and/or UI 1000 in FIG. 10) of the search results. In some implementations, the system can cause presentation of a document generation interface and/or a workflow structure generation interface (e.g., document generation interface 1010 in FIG. 10, which can also function as a workflow generation interface).

At 1108, the system can receive, via an interface of the workspace (e.g., at document generation input field 1012 of the document generation interface 1010 in FIG. 10, which can also function as a workflow generation interface; input field 1002 of UI 1000 in FIG. 10; the search input field 302 of UI 300 in FIGS. 3A and 3B, the search bar 312 of UI 300 in FIG. 3B, the chat input field 336 in FIGS. 3B and 4, the first input field 702, and/or the second input field 704 in FIGS. 7 and 8) an instruction to generate a document (e.g., text document, email, webpage, workflow structure) based on at least a portion of the search results. The portion of the search results (e.g., used to generate, in part, the document) includes content items accessible via the workspace and/or the natural language response. In some implementations, each of the presented references to content items (e.g., in the presented search results) is selectable (e.g., through the interface of the workspace), and the portion of the search results includes the content items indicated to by selected references and/or the natural language response. For example, the portion of the search results can include only the content items referred to by the selected references and/or the natural language response.

In some implementations, the interface comprises an interface element (e.g., document generation interface elements 1014 and/or suggested action 1016 of the document generation interface 1010 of UI 1000 in FIG. 10) configured to provide instructions to an AI system (e.g., natural language instructions) to generate the document (e.g., in response to a selection of the interface element), and receiving the instruction to generate the document involves receiving a user selection of the interface element. In some implementations, the interface includes a plurality of selectable interface elements, each associated with a different document type option. Examples of document type options can include file type, content, style, formatting, and the like, and can include whether the document should be a content item of the workspace and/or a workflow structure (e.g., schedule, tracker). The instruction to generate a document can include a selection of a selectable interface element of the plurality of selectable interface elements, where the selected interface element is associated with a particular document type option, and a type of the generated document is determined by the particular document type option associated with the selected interface element. In some implementations, the selectable interface elements are configured to provide instructions to an AI system, where the prompt provided is dependent on the particular selectable interface element that is selected by the user. For example, an element associated with a PDF format can provide a prompt “create a PDF document based on the search results,” while an element associated with a spreadsheet format can provide a prompt “create a spreadsheet document based on the search results.” In some implementations, one or more of the selectable interface elements (e.g., selectable interface elements 1014 in FIG. 10), document generation suggestions (e.g., suggested action 1016 in FIG. 10), and/or inputs to a document generation input field (e.g., document generation input field 1012 of FIG. 10 and/or search input fields, such as input field 1002 of FIG. 10) can provide prompts to an AI system (e.g., the same AI system in each case).

In some implementations, the interface includes an input field (e.g., input field 1002 and/or document generation input field 1012 of UI 1000 in FIG. 10, the search input field 302 in FIGS. 3A and 3B, the search bar 312 in FIG. 3B, the chat input field 336 in FIGS. 3B and 4, the first input field 702, and/or the second input field 704 in FIGS. 7 and 8), and the instruction to generate the document includes a natural language instruction received at the input field (e.g., provided by a user at the input field). In some implementations, the natural language instruction received at the input field (e.g., provided by a user at the input field) is processed using an AI system to determine parameters for generating the document (e.g., size, type, format, content). In some implementations, the input field can be the same input field that receives search queries (e.g., the interface includes an input field, the search query is received at the input field, and the document generation instruction is received at the same input field). In some implementations, the natural language instruction provided by a user at the input field identifies certain content items which are then included in the portion of the search results. For example, the natural language instruction can identify certain content items, and the portion of the search results can include only the content items identified in the natural language instruction.

At 1110, the system can generate the document (e.g., a workflow structure) based on at least the instruction and the portion of the search results. The document (e.g., the document illustrated in the document preview 1022 of FIG. 10) can include content generated by an AI system based on the portion of the search results (e.g., used to generate, in part, the document content). In some implementations, the document is a content item contained in the workspace (e.g., a page and/or webpage, a document embedded in a page). The document can additionally contain one or more dynamic elements (e.g., an automatically updating element that includes a value that dynamically reflects an attribute of the workspace, and/or an interactive element such as a checkbox, as illustrated by dynamic element 1024 in FIG. 10).

In some implementations, the generated document is a workflow structure, including a set of interconnected tasks or activities (e.g., generated by an AI system) based on the portion of the search results. For example, the workflow structure can be a schedule (e.g., the set of interconnected tasks or activities is arranged in a temporal order). The schedule can, additionally or alternatively, be provided on a calendar associated with the workspace, and the calendar can include an interactive element that, when activated through an interface of the workspace, updates a status of a task or activity in the calendar. In another example, the workflow structure can be a tracker (e.g., the set of tasks or activities are arranged in a hierarchical order). The tracker can include an interactive element that, when activated through an interface of the workspace, updates a status of a task to be completed in the workspace.

At 1112, the system can provide the document (e.g., workflow structure) on an interface of the workspace. The document can be provided in a document preview window (e.g., document preview 1022 shown inside document preview window 1020 in FIG. 10). The document can be a webpage, and the interface can redirect a user to the webpage (e.g., providing a link or by automatically redirecting the user, which can include opening another window or tab of a web browser). The document can be included in another page of the workspace (e.g., an image embedded in a page, or a schedule that is part of a calendar), and the interface can redirect a user to the webpage or display a preview of the document (e.g., showing a preview of the document and the page that it is part of in document preview window 1020). The document can be a file, and the system can allow a user to download the file (e.g., automatically or by presenting a download interface element).

In some implementations, the system provides the capability to create multiple search results (for example, as part of a chat session with an AI system, as illustrated by UI 300 in FIG. 4 and/or chat window 810 of UI 700 in FIG. 8) and generate a document based in part on some or all of the results. For example, a system can receive (e.g., prior to receiving the instruction to generate the document) a second search query for content items accessible via the workspace, compile second search results that satisfy the second search query (e.g., including second references to content items that satisfy the second search query and are accessible via the workspace, and/or a second natural language response that can be generated as output of an AI system based at least in part on input including the content items that satisfy the second search query). Generating the document can then include generating a document based at least in part on some or all of the results, such as the portion of the (first) search results, content items that satisfy the second search query, and/or the second natural language response. In some implementations, the search results and/or generated documents can be stored as part of a search session.

In some implementations, the system can receive, on an interface of the workspace, a first search query for content items accessible via the workspace, compile first search results that satisfy the search query, including first references to content items accessible via the workspace that satisfy the first search query and a first natural language response to the search query (e.g., generated as output of a generative artificial intelligence (AI) system based at least in part on input including the content items that satisfy the first search query), and cause presentation, on the interface of the workspace, of the first search results and a document generation interface. The system can receive (e.g., prior to receiving an instruction to generate a document) a second search query for content items accessible via the workspace and compile second search results that satisfy the second search query, including second references to content items accessible via the workspace that satisfy the second search query, and including a second natural language response (e.g., generated as output of an AI system based at least in part on input including the content items that satisfy the second search query). The system can receive, via the document generation interface, an instruction to generate a document. The instruction can be based on a portion of the first and/or second search results, including content items accessible via the workspace and/or the first and/or second natural language responses. The system can generate a document based on the instruction and at least a portion of the search results, including a portion of the first results and content items that satisfy the second search query and/or the second natural language response. The document can include content generated by the AI system based on the at least a portion of the search results. The system can provide the document (e.g., on the document generation interface of the workspace).

### Computer System

FIG. 12 is a block diagram that illustrates an example of a computer system 1200 in which at least some operations described herein can be implemented. As shown, the computer system 1200 can include: one or more processors 1202, main memory 1206, non-volatile memory 1210, a network interface device 1212, a display device 1218, an input/output device 1220, a control device 1222 (e.g., keyboard and pointing device), a drive unit 1224 that includes a machine-readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computer system 1200 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 1200. In some implementations, the computer system 1200 can be an embedded computer system, a system-on-chip (SOC), a single-board computer (SBC) system, or a distributed system such as a mesh of computer systems or include one or more cloud components in one or more networks. Where appropriate, one or more computer systems 1200 can perform operations in real time, near real time, or in batch mode.

The network interface device 1212 enables the computer system 1200 to mediate data in a network 1214 with an entity that is external to the computer system 1200 through any communication protocol supported by the computer system 1200 and the external entity. Examples of the network interface device 1212 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computer system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computer system 1200 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A computer-implemented method for performing navigational and exploratory searches of content accessible via a workspace, the workspace including a collection of content items, the method comprising:
receiving, at a first input field, a preliminary search query for content items that are accessible via the workspace;
identifying a first set of content items that satisfy the preliminary search query;
generating, using an artificial intelligence (AI) system, a first natural language response that satisfies the preliminary search query,
wherein the first natural language response is generated based on content items that are accessible via the workspace;
causing presentation, on an interface of the workspace, of:
preliminary search results including indications of the first set of content items and the first natural language response, and
a second input field configured to enable investigation of the preliminary search results;
receiving, at the second input field, a refined search query in a natural language format; and
causing presentation, on the interface of the workspace, of refined search results including indications of a second set of content items and a second natural language response that satisfies the refined search query.

2. The computer-implemented method of claim 1, further comprising:
embedding links to particular content items in a particular natural language response that satisfies a particular search result.

3. The computer-implemented method of claim 1, wherein the preliminary search results correspond to first preliminary search results, wherein receiving the preliminary search query at the first input field initiates a first search session, and wherein the method further comprises:
initiating a second search session by receiving a second preliminary search query for content items that are accessible via the workspace; and
causing presentation, on the interface of the workspace, of a third input field and second preliminary search results including a third set of content items and a third natural language response,
wherein the third input field is configured to enable investigation of the second preliminary search results, and
wherein (i) the first search session comprising the first set of content items, the first natural language response, and the second input field and (ii) the second search session comprising the third set of content items, the third natural language response, and the third input field are both accessible via the interface of the workspace.

4. The computer-implemented method of claim 3, further comprising:
causing presentation, on the interface of the workspace, of an interface element,
wherein activating the interface element indicates an intent to change search sessions; and
causing presentation, on the interface of the workspace, of the first preliminary search results and the second input field.

5. The computer-implemented method of claim 1, wherein the first set of content items is an empty set containing zero content items, wherein the first natural language response identifies that no content items were found, and wherein the method further comprises:
in response to the first set of content items being an empty set, initialize an AI-enabled chat session, wherein the second input field is configured to receive a new search query.

6. The computer-implemented method of claim 1, wherein each item in the first set of content items is retrievable from the workspace.

7. The computer-implemented method of claim 1, wherein a portion of the content items accessible via the workspace are content items retrieved from a source that is outside of the workspace.

8. The computer-implemented method of claim 7, wherein the method further comprises:
causing presentation, on the interface of the workspace, a list of one or more sources of content items, the content items being accessible via the workspace,
wherein each of the one or more sources is selectable through the interface of the workspace; and
wherein the preliminary search results only include content items in the first set of content items that are from one or more selected sources.

9. The computer-implemented method of claim 1, wherein the first natural language response is generated based on content items in the first set of content items.

10. The computer-implemented method of claim 1, further comprising, prior to generating the first natural language response that satisfies the preliminary search query:
initialize a chat session with the AI system,
wherein the chat session includes a series of exchanges, comprising inputs and responses, in which context is maintained between exchanges in the series; and
inputting, as part of the chat session, the refined search query to the AI system to generate the second natural language response.

11. The computer-implemented method of claim 1, wherein the content items are blocks of the workspace, wherein the blocks are configured in accordance with a block data model.

12. At least one non-transitory, computer-readable storage medium comprising instructions recorded thereon, wherein the instructions, when executed by at least one data processor of a system, cause the system to:
identify a first set of content items satisfying a preliminary search query,
wherein each of the first set of content items are accessible via a workspace, and
wherein the preliminary search query is entered into a first input field;
generate, using an artificial intelligence (AI) system, a first natural language response that satisfies the preliminary search query,
wherein the first natural language response is generated based at least in part on content items accessible via the workspace;
cause presentation, on an interface of the workspace, of:
preliminary search results including indications of the first set of content items and the first natural language response, and
a second input field; and
cause presentation, on the interface of the workspace, of refined search results including a second natural language response that satisfies a refined search query,
wherein the refined search query is entered into the second input field.

13. The at least one non-transitory, computer-readable storage medium of claim 12, wherein the preliminary search results correspond to first preliminary search results, wherein a first search session is initiated in response to the preliminary search query being entered into the first input field, and wherein the storage medium further includes instructions to cause the system to:
initiate a second search session in response to second preliminary search query being entered into a third input field; and
cause presentation, on the interface of the workspace, of a fourth input field and a third natural language response that satisfies the second preliminary search query,
wherein (i) the first search session containing the first set of content items, the first natural language response, and the second input field and (ii) the second search session containing, the third natural language response and the fourth input field are both accessible via the interface of the workspace.

14. The at least one non-transitory, computer-readable storage medium of claim 13, wherein the third input field is the first input field.

15. The at least one non-transitory, computer-readable storage medium of claim 12, wherein a portion of the content items accessible via the workspace are content items from a source that is outside of the workspace.

16. The at least one non-transitory, computer-readable storage medium of claim 15, wherein the storage medium further includes instructions to cause the system to:
cause presentation, on the interface of the workspace, a list of one or more sources of content items, the content items being accessible via the workspace,
wherein each of the one or more sources is selectable through the interface of the workspace; and
wherein the preliminary search results only include content items in the first set of content items that are from one or more selected sources.

17. The at least one non-transitory, computer-readable storage medium of claim 12, wherein the storage medium further includes instructions to cause the system to:
concurrent with causing presentation the refined search results, cause presentation of an interface element,
wherein interacting with the interface element causes presentation of indications of a second set of content items satisfying the refined search query.

18. A system comprising:
at least one hardware processor; and
at least one non-transitory memory storing instructions, which, when executed by the at least one hardware processor, cause the system to:
generate, using an artificial intelligence (AI) system, a first natural language response satisfying a preliminary search query,
wherein the preliminary search query is entered into a first input field;
cause presentation, on a user interface, of:
preliminary search results including the first natural language response, and
a second input field; and
cause presentation, on the user interface, of refined search results including a set of content items satisfying a refined search query and a second natural language response satisfying the refined search query,
wherein the refined search query is entered into the second input field,
wherein each of the set of content items are accessible via a workspace.

19. The system of claim 18, wherein instructions stored on the memory further cause the at least one hardware processor to, prior to generating the first natural language response:
initialize a chat session with the AI system,
wherein the chat session includes a series of exchanges, comprising inputs and responses, in which context is maintained between exchanges in the series; and
input, as part of the chat session, the refined search query to the AI system to generate the second natural language response.

20. The system of claim 18, wherein the preliminary search query correspond to first preliminary search query, wherein the preliminary search results corresponds to first preliminary search results, wherein instructions stored on the memory further cause the at least one hardware processor to:
generate, using the AI system, a third natural language response satisfying a second preliminary search query,
wherein the preliminary search query is entered into a third input field;
cause presentation, on the user interface, of second preliminary search results including the third natural language response and a fourth input field,
wherein (i) the first preliminary search results including the first natural language response and the second input field and (ii) the second preliminary search results including the third natural language response and the fourth input field are both accessible via the user interface.
